(19) United States
(12) Patent Application Publication
(10) Pub. No.: US 2011/0228949 A1
(43) Pub. Date: Sep. 22, 2011

(54) SPEAKER DEVICE, AND AUTOMOBILE

(75) Inventors: Takahisa Haba, Yamagata (JP); Hiroya Oizumi, Yamagata (JP); Kyoichi Matsuda, Yamagata (JP); Takuei Nagasawa, Yamagata (JP)

(73) Assignees: PIONEER CORPORATION, Tokyo (JP); TOHOKU PIONEER CORPORATION, Yamagata (JP)

(21) Appl. No.: 13/126,955

(22) PCT Filed: Oct. 31, 2008
(86) PCT No.: PCT/JP2008/069962

§ 371 Date: Jun. 2, 2011

(51) Int. Cl. H04B 1/00; H04R 9/04

(52) U.S. Cl. 381/86; 381/398

(57) ABSTRACT

A speaker device prevents “squeaking” based on the difference between propagation speed of a vibration propagated through a center cap and propagation speed of a vibration propagated through a diaphragm. The speaker device includes a vibrating body (VB), a driving part (magnetic circuit) driving the VB, and a frame supporting the VB and the driving part (magnetic circuit). The VB includes a voice coil (VC), a VC supporting part supporting the VC, a diaphragm group, and a driving member whose inner circumference portion is supported by the VC supporting part and which transmits VC vibration to the diaphragm group. The driving member includes a supporting part supporting the diaphragm group. A first connecting part is provided between the diaphragm group and the driving member and on the inner side with respect to the supporting part. The diaphragm group is connected to the driving member via the first connecting part.

### TECHNICAL FIELD

The present invention relates to a speaker device which is large in diameter and comparatively thin in thickness, and is preferably used for, for example, an on-vehicle subwoofer and the like, and to a vehicle including the speaker device.

### BACKGROUND ART

Some conventional speaker devices include a center cap mounting structure where a circumferential groove is formed in a center cap mounting position of a diaphragm, and an attaching portion of a center cap is inserted and fixed to the circumferential groove (for example, refer to Patent Document 1).
Patent Document 1: Japanese Utility Model Application Laid-Open Publication No. SHO 58-127793

### DISCLOSURE OF THE INVENTION

### Problems to be Solved by the Invention

In the above-described conventional speaker devices, an outer circumference portion of the center cap is supported by the diaphragm. However, the center cap is not supported in the vicinity of a center portion thereof. Hence, the rigidity in the vicinity of the center portion of the center cap is comparatively low with respect to the rigidity in the outer circumference portion of the center cap. Especially, when the speaker device is driven, the acceleration in a specific portion of the center cap at a predetermined frequency becomes comparatively larger than the acceleration in another portion. That is, a so-called “squeaking” (abnormal sound) phenomenon occurs.

Additionally, in the conventional speaker devices, the outer circumference portion of the center cap extends across a sound emission direction with respect to the diaphragm. Hence, a comparatively large phase difference occurs between a sound wave emitted from the center cap and a sound wave emitted from the diaphragm, and the sound waves interfere with each other (counteract with each other). Thus, there is a problem that a good acoustic characteristic cannot be provided.

The present invention is made in view of the above-described situation, and one example of the objects is to solve the problems as described above. The present invention aims to provide a speaker device which can solve these problems and to provide a vehicle including the speaker device.

### Means for Solving the Problem

In order to solve the above-described problems, a speaker device according to the invention claimed in claim 1 includes: a vibrating body; a driving part which drives the vibrating body; and a frame which supports the vibrating body and the driving part, the vibrating body including a voice coil, a voice coil supporting part supporting the voice coil, a diaphragm, and a driving member whose inner circumference portion is supported by the voice coil supporting part, the driving member transmitting a vibration of the voice coil to the diaphragm, the driving member including a supporting part which supports the diaphragm, wherein a connecting part is provided between the diaphragm and the driving member and on an inside with respect to the supporting part, and the diaphragm is connected to the driving member via the connecting part.

### BRIEF DESCRIPTION OF THE DRAWINGS

FIG. 1 is a front view illustrating a structure of a speaker device according to Embodiment 1 of the present invention;

FIG. 2 is an A-A cross-sectional view of FIG. 1;

FIG. 3 is a perspective view illustrating a state where a driving member and a diaphragm group forming the speaker device shown in FIG. 1 are assembled;

FIG. 4 is a side view illustrating the state where the diaphragm group and the driving member are assembled;

FIG. 5 is a perspective view illustrating a state where the diaphragm group and the driving member are being assembled;

FIG. 6 is a front view illustrating a structure of a first diaphragm which is a part of the diaphragm group;

FIG. 7 is a front view illustrating a state where an annular member, which is a part of the diaphragm group, is placed on the first diaphragm;

FIG. 8 is a front view illustrating a state where a first edge is mounted to a second diaphragm;

FIG. 9 is a rear view illustrating the state where the first edge is mounted to the second diaphragm;

FIG. 10 is a perspective view illustrating a structure of the driving member;

FIG. 11 are diagrams illustrating the structure of the driving member, wherein (a) is a plan view, and (b) is a cross-sectional view;

FIG. 12 is a cross-sectional view illustrating a structure of a speaker device according to Embodiment 2 of the present invention;

FIG. 13 is an enlarged view of a part A of FIG. 12;

FIG. 14 is a front view illustrating a state where a first edge is mounted to a diaphragm group;

FIG. 15 is a rear view illustrating the state where the first edge is mounted to the diaphragm group;

FIG. 16 are diagrams illustrating a structure of a first diaphragm which is apart of the diaphragm group forming the speaker device shown in FIG. 12, wherein (a) is a front view, and (b) is an A-A cross-sectional view of (a);

FIG. 17 is a rear view illustrating a structure of the first diaphragm;

FIG. 18 is a front view illustrating a state where the first edge is mounted to a second diaphragm which is apart of the diaphragm group;

FIG. 19 is a rear side perspective view illustrating a structure of the second diaphragm;

FIG. 20 is a perspective view illustrating a structure of a connecting part which is a part of the diaphragm group;

FIG. 21 is a side view illustrating the structure of the connecting part shown in FIG. 20;

FIG. 22 is a front view illustrating a state where the connecting part is placed on the second diaphragm to which the first edge is mounted;

FIG. 23 is a graph illustrating, during driving of the speaker device according to Embodiment 2 of the present invention, an example of a characteristic of a vibration acceleration with respect to a frequency at each point of the first diaphragm forming the speaker device;

FIG. 24 is a graph illustrating, during driving of a conventional speaker device, an example of a characteristic of a vibration acceleration with respect to a frequency at each point of a first diaphragm forming the speaker device;

FIG. 25 is a cross-sectional view illustrating a structure of a speaker device according to Embodiment 3 of the present invention;

FIG. 26 is an enlarged view of a part A of FIG. 25;

FIG. 27 is a front view illustrating a state where an edge is mounted to a diaphragm group forming the speaker device shown in FIG. 25;

FIG. 28 are diagrams illustrating a structure of a first diaphragm forming the speaker device shown in FIG. 25, wherein (a) is a front view, and (b) is an A-A cross-sectional view of (b);

FIG. 29 is a rear view illustrating the structure of the first diaphragm;

FIG. 30 is a front view illustrating a state where the edge is mounted to a second diaphragm;

FIG. 31 is a perspective view illustrating the state where the edge is mounted to the second diaphragm;

FIG. 32 is a rear view illustrating the state where the edge is mounted to the second diaphragm;

FIG. 33 is a graph illustrating, during driving of the speaker device according to Embodiment 3 of the present invention, an example of a characteristic of a vibration acceleration with respect to a frequency at each point of the first diaphragm forming the speaker device;

FIG. 34 is a graph illustrating, during driving of a conventional speaker device, an example of a characteristic of a vibration acceleration with respect to a frequency at each point of a first diaphragm forming the speaker device; and

FIG. 35 is a cross-sectional view illustrating a structure of a vehicle door to which a speaker device according to each embodiment of the present invention is mounted.

### BEST MODE FOR CARRYING OUT THE INVENTION

Hereinafter, the best mode for carrying out the present invention will be described with reference to the drawings.

### Embodiment 1

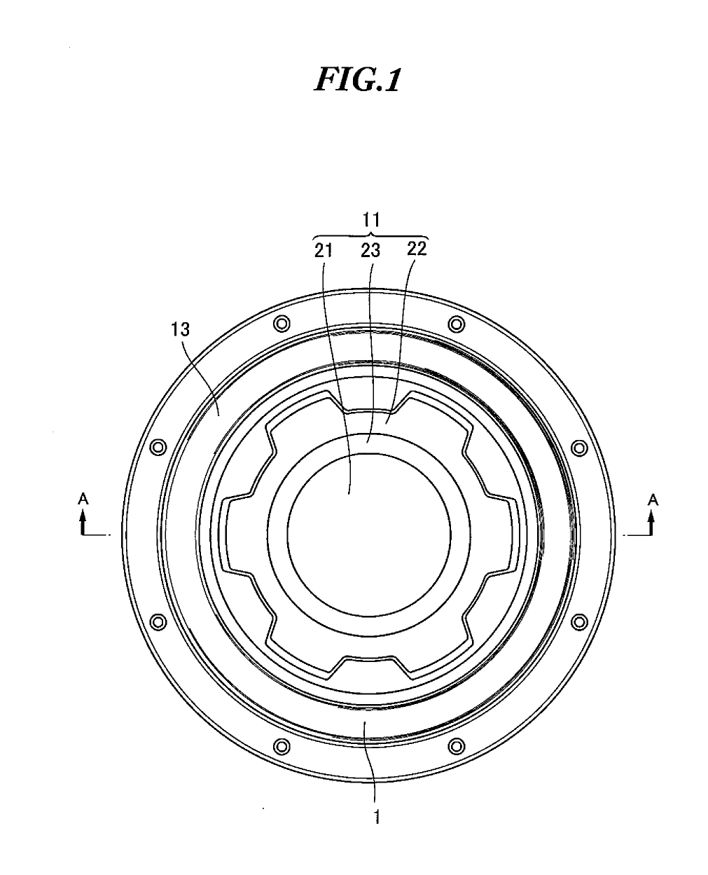

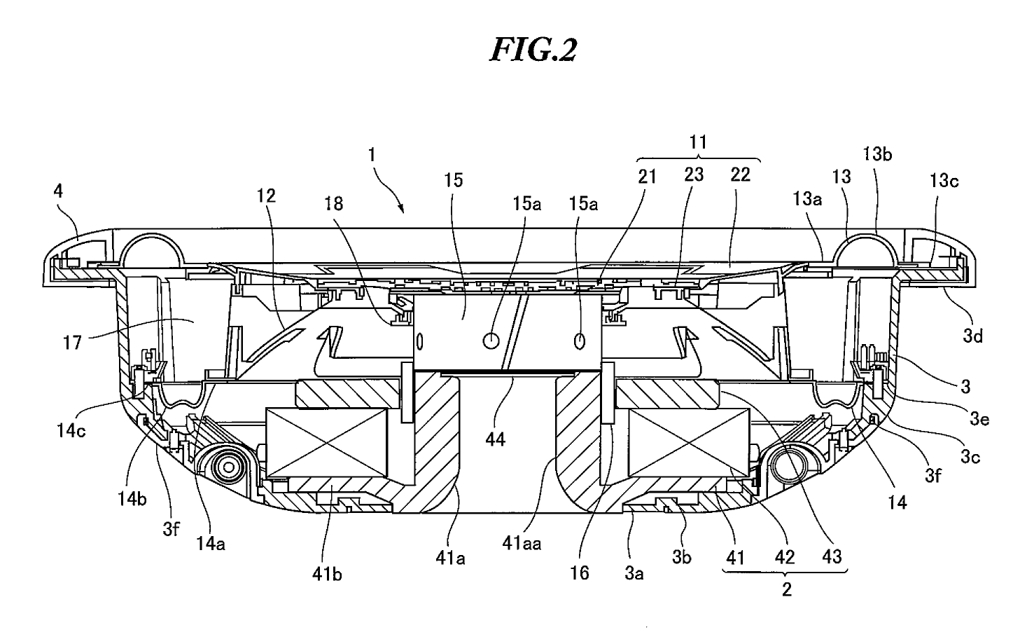

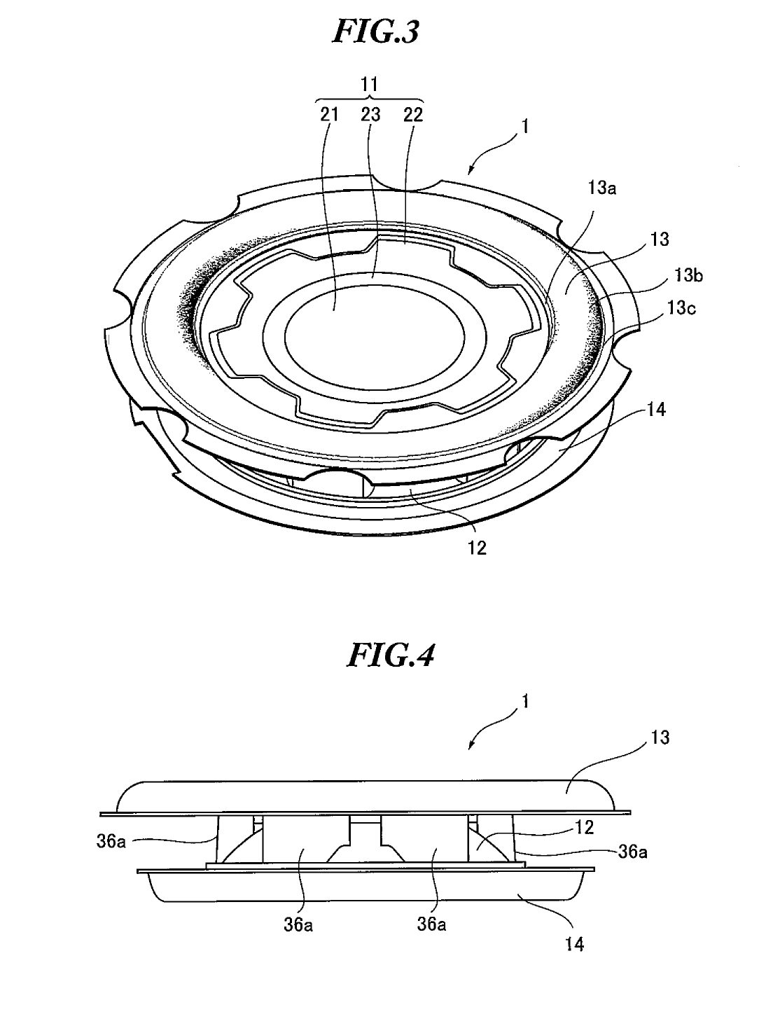

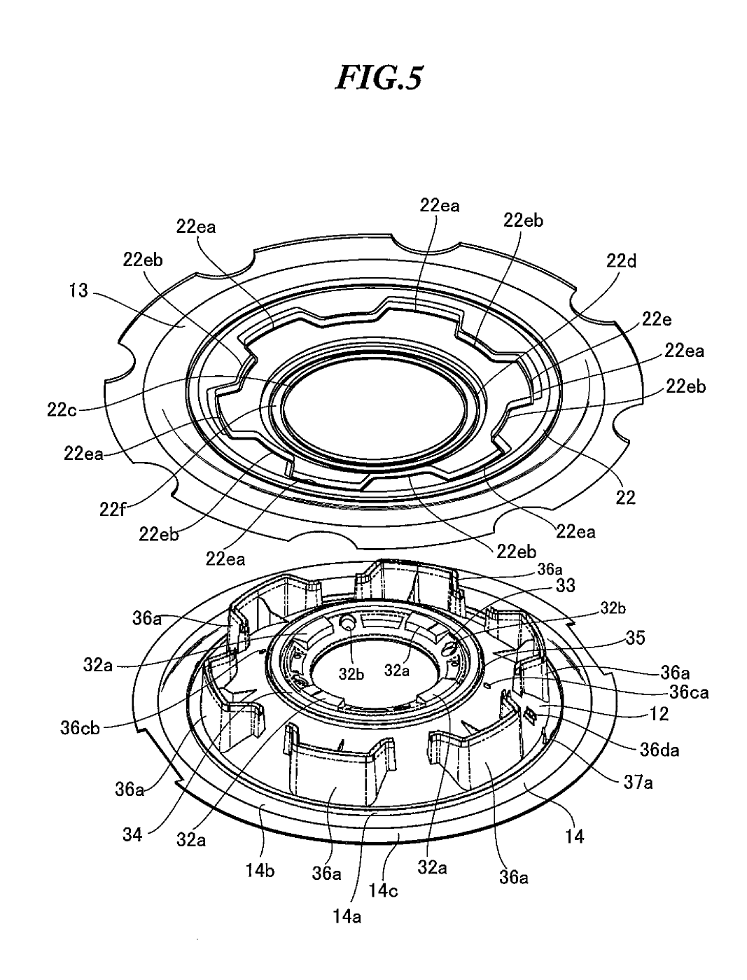

FIG. 1 is a front view illustrating a structure of a speaker device according to Embodiment 1 of the present invention. FIG. 2 is an A-A cross-sectional view of FIG. 1. Additionally, FIG. 3 is a perspective view illustrating a state where a diaphragm group 11 and a driving member 12 forming the speaker device shown in FIG. 1 are assembled, FIG. 4 is a side view illustrating the state where the diaphragm group 11 and the driving member 12 are assembled, and FIG. 5 is a perspective view illustrating a state where the diaphragm group 11 and the driving member 12 are being assembled.

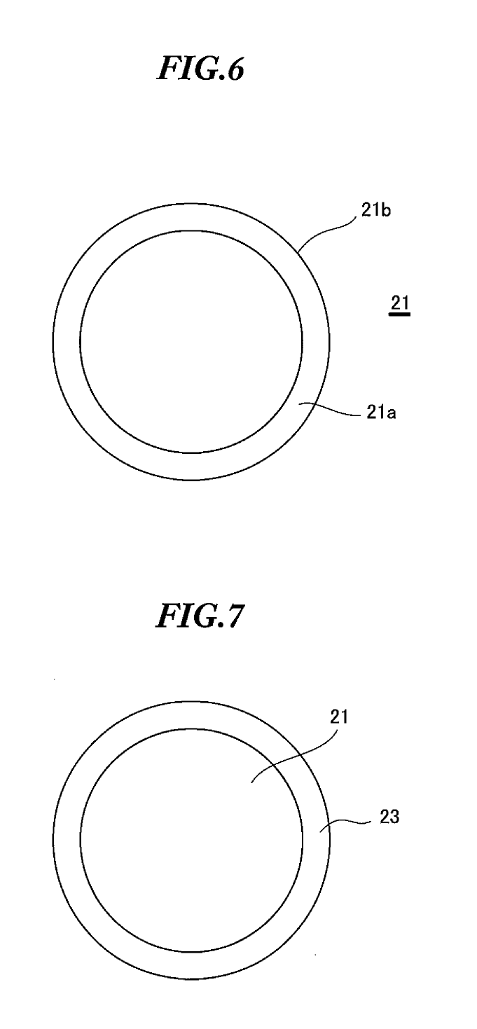

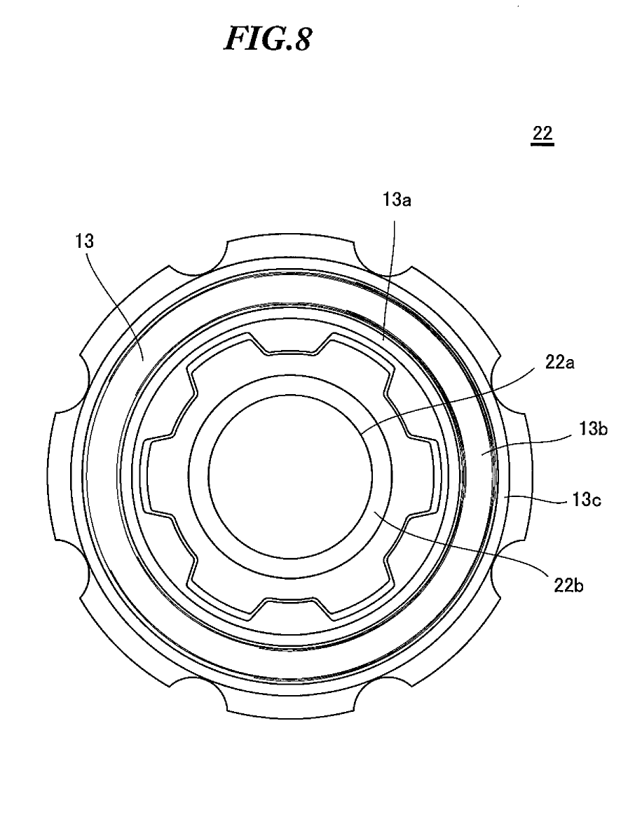

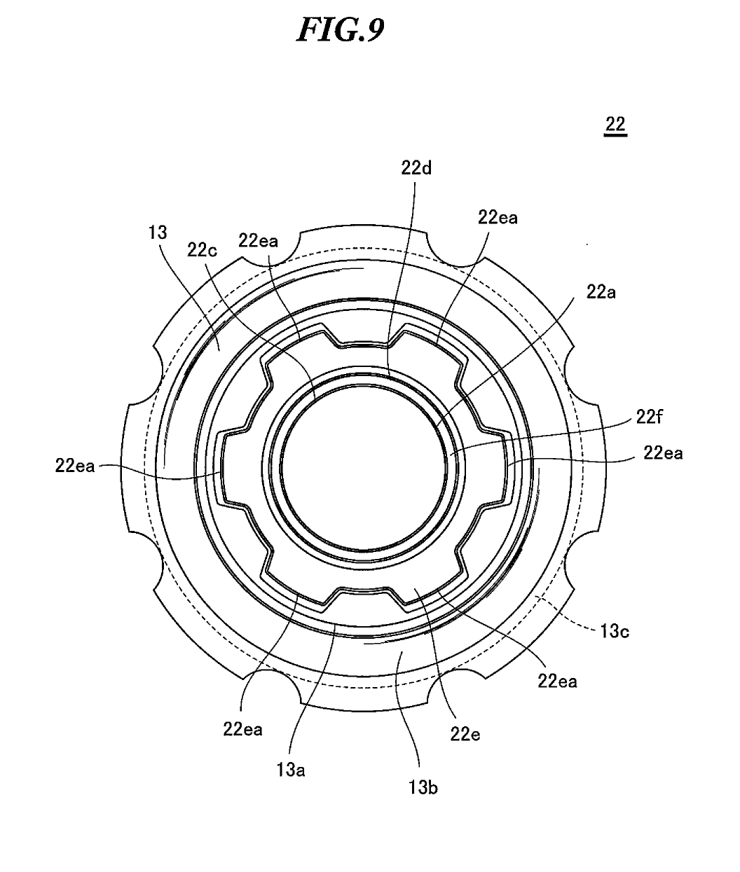

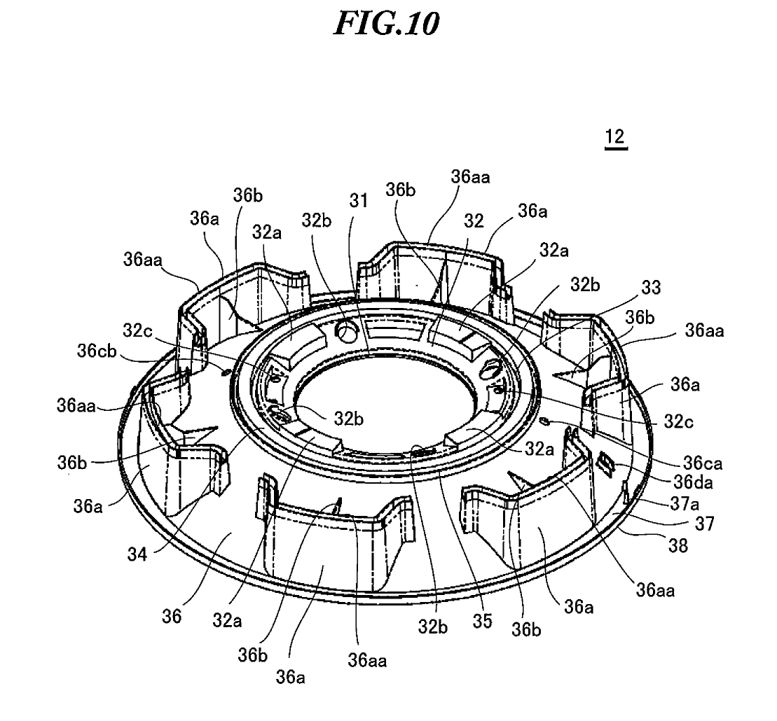

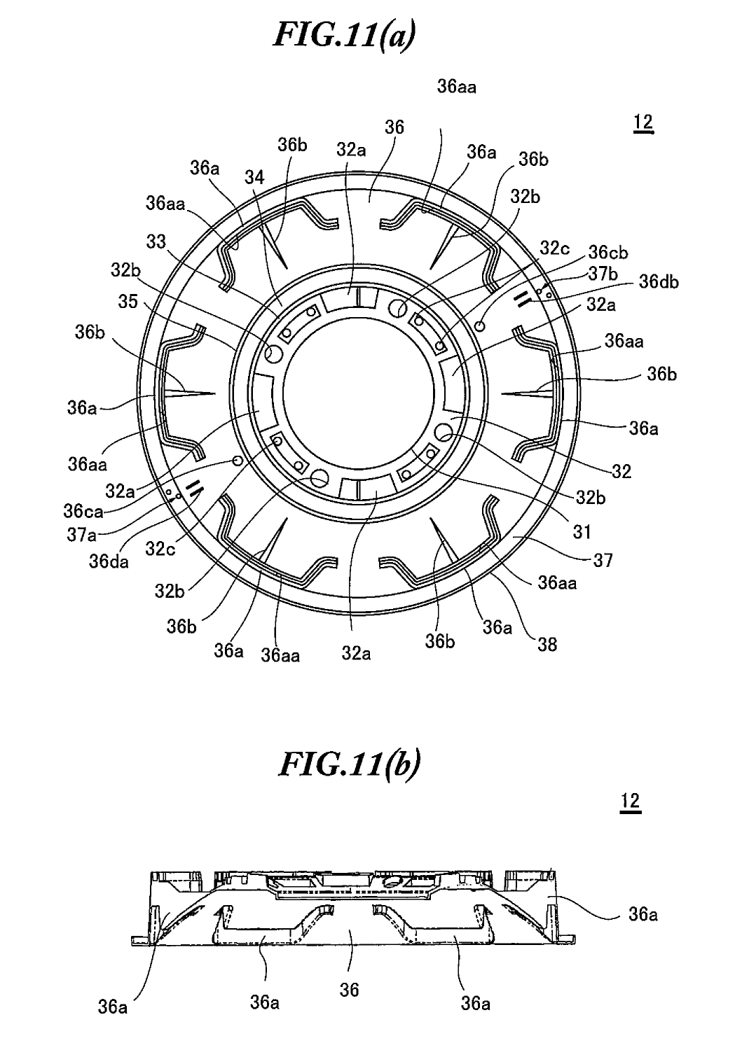

Furthermore, FIG. 6 is a front view illustrating a structure of a first diaphragm 21 which is a part of the diaphragm group 11, and FIG. 7 is a front view illustrating a state where an annular member 23, which is a part of the diaphragm group 11, is placed on the first diaphragm 21. In addition, FIG. 8 is a front view illustrating a state where a first edge 13 is mounted to a second diaphragm 22, and FIG. 9 is a rear view illustrating the state where the first edge 13 is mounted to the second diaphragm 22. Further, FIG. 10 is a perspective view illustrating a structure of the driving member 12, and FIG. 11 are diagrams illustrating the structure of the driving member 12, wherein (a) is a front view, and (b) is a cross-sectional view.

The speaker device according to the present Embodiment 1 includes a vibrating body 1, a magnetic circuit 2, and a frame (a speaker frame) 3. The vibrating body 1 includes the diaphragm group 11, the driving member (drive cone) 12, the first edge 13, a second edge 14, a voice coil supporting part (voice coil bobbin) 15, and a voice coil 16. In other words, the speaker device according to the present Embodiment 1 is a so-called double-cone type where the vibrating body 1 includes the diaphragm group 11 and the driving member 12.

In the speaker device, as shown in FIG. 2, a sealed space 17 is formed so as to be surrounded by the frame 3, the driving member 12, and the second diaphragm 22, which will be described later. A gas filled in the sealed space 17 is, for example, a gas such as the air, and is regulated to be a predetermined pressure, for example, a normal pressure (atmospheric pressure). That is, the speaker device having the above-described structure is a dumperless speaker device where the air in the sealed space 17 functions as an air spring (air dumper) to support the vibrating body 1. The volume of the sealed space 17 affects a spring constant, particularly, a stiffness. Hence, in the speaker device according to the present Embodiment 1, the volume of the sealed space 17 is determined to have a predetermined stiffness.

Hereinafter, each element of the speaker device will be described with reference to the drawings. The diaphragm group 11 includes the first diaphragm (center cap) 21, the second diaphragm 22, and the annular member 23. The diaphragm group 11 is, as shown in FIG. 1, a substantially circular shape in a plan view in a state where the first diaphragm 21, the second diaphragm 22, and the annular member 23 are fixed to each other by an adhesive or the like. Furthermore, a longitudinal sectional shape of the diaphragm group 11 in the fixed state is a substantially circular truncated cone shape (cone shape) which is extremely small in a longitudinal direction (vibration direction) compared with the outer diameter.

The materials of the first diaphragm 21 and the second diaphragm 22 include, for example, a synthetic resin, an acrylic foam, and a hybrid material formed by a synthetic resin and a metal. The synthetic resin includes, for example, an olefin-system resin such as polypropylene, a thermoplastic resin such as an ABS (Acrylonitrile Butadiene Styrene) resin and a Polyethylene terephthalate-system, a polycarbonate resin, a thermosetting resin such as an epoxy resin, and a rubber. Additionally, the acrylic foam, which is a foam resin, is formed by using, for example, methyl methacrylate, methacrylic acid, styrene, maleic anhydride, and methacrylamide as the materials. A known foam resin may be used for the first diaphragm 21 and the second diaphragm 22. The hybrid material is made from, for example, a synthetic resin such as polypropylene and a metal such as tungsten. In addition, the same material or different materials may be used for the first diaphragm 21 and the second diaphragm 22. On the other hand, the material of the annular member 23 may be a metal material such as aluminum, titanium, beryllium, magnesium, or an alloy of these, or an alloy of other metals.

The first diaphragm 21 is a substantially disc shape as shown in FIG. 6. A step portion 21a on which the annular member 23 is placed is formed on a surface of an outer circumference portion of the first diaphragm 21. The height of the step portion 21a is, for example, substantially equal to the thickness of the annular member 23. Therefore, as shown in FIG. 7, when the annular member 23 is fixed to the step portion 21a of the first diaphragm 21 by an adhesive or the like, surfaces (in a sound emission direction) of the first diaphragm 21 and the annular member 23 are positioned on the substantially same plane to form a substantially flat surface.

On the other hand, the second diaphragm 22 is a substantially annular shape as shown in FIG. 8 and FIG. 9. The inner diameter of an inner circumference portion 22a of the second diaphragm 22 is formed smaller than the outer diameter of an outer circumference portion 21b of the first diaphragm 21 (Refer to FIG. 6). In a surface of the inner circumference portion of the second diaphragm 22, a step portion 22b is formed on which the first diaphragm 21 and the annular member 23 are placed. The height of the step portion 22b is, for example, substantially equal to the thickness of the first diaphragm 21 on which the annular member 23 is placed. Therefore, when the first diaphragm 21 to which the annular member 23 is fixed to the step portion 22b of the second diaphragm 22 by an adhesive or the like, surfaces (in the sound emission direction) of the first diaphragm 21, the second diaphragm 22, and the annular member 23 are positioned on the substantially same plane to form a substantially flat surface.

As shown in FIG. 9, protruding portions 22c and 22d, having annular shapes with different diameters and protruding in the direction opposite to the sound emission direction, are formed in the inner circumference portion and on a rear surface of the second diaphragm 22. The protruding portion 22c is formed in the innermost circumference of the second diaphragm 22, and the protruding portion 22d is formed closer to an outer circumference with a predetermined distance from the protruding portion 22c. The width of the protruding portion 22c is, for example, approximately one and a half times of the width of the protruding portion 22d. As shown in FIG. 5, when the second diaphragm 21 and the driving member 12 are assembled, these protruding portions 22c and 22d are fitted into a first groove portion 33 and a second groove portion 35 (refer to FIG. 10 and FIG. 11) formed on the driving member 12, and a ridge portion 34 formed on the driving member 12 is fitted into and fixed to, by an adhesive or the like, a groove portion 22f between the protruding portion 22c and the protruding portion 22d. As described above, a joint is made by an adhesive or the like in the state where the protruding portions 22c and 22d of the second diaphragm 22 are fitted into the first groove portion 33 and the second groove portion 35 of the driving member 12, respectively, and the ridge portion 34 of the driving member 12 is fitted into the groove portion 22f of the second diaphragm 22. Therefore, a comparatively large joint strength is obtained.

As shown in FIG. 9, a convex portion 22e, which is substantially equal to the outer shape of a gear having six teeth in a plan view, is formed to protrude in the direction opposite to a sound emission side on the rear surface of the second diaphragm 22 and in a substantially center in a circumference direction of the second diaphragm 22. When the second diaphragm 21 and the driving member 12 are assembled as shown in FIG. 5, a part of each mountain portion 22ea and each valley portion 22eb of the convex portion 22e are fitted into and fixed to, by an adhesive or the like, six second connecting parts 36a formed on the driving member 12 (refer to FIG. 10 and FIG. 11). In this manner, the convex portion 22e is connected to the corresponding second connecting parts 36a formed on the driving member 12, and the second diaphragm 22 is supported by the driving member 12.

In the speaker device according to the present Embodiment 1, the convex portion 22e of the second diaphragm 22 is supported by the second connecting parts 36a formed on the driving member 12. Thus, for example, compared with a case of supporting, by the second connecting parts 36a, the second diaphragm 22 having a simple flat plate shape where the convex portion 22e is not formed, the second diaphragm 22 has a comparatively large rigidity, and a distortion of the second diaphragm 22 is reduced when transmitting a driving force from the driving member 12 to the second diaphragm 22. Therefore, it is possible to transmit the driving force with a comparatively high efficiency.

An inner circumference portion 13a of the first edge 13 is fixed, by an adhesive or the like, to the outer circumference portion of the second diaphragm 22 as shown in FIG. 8, FIG. 9 and the like. The first edge 13 has an appropriate compliance (rigidity), and is not air permeable. The first edge 13 is constructed by integrally forming the inner circumference portion 13a, the convex portion 13b, and an outer circumference portion 13c. The first edge 13 is a substantially annular shape in an entire plan view. Longitudinal sectional shapes of the inner circumference portion 13a and the outer circumference portion 13c are flat shapes. On the other hand, a longitudinal sectional shape of the convex portion 13b has a substantially roll shape protruding toward the surface side (sound emission direction). As shown in FIG. 2, the outer circumference portion 13c is fixed, by an adhesive or the like, to an upper flat portion 3d of the frame 3, which will be described later. As described above, the diaphragm group 11 is connected to the frame 3 via the first edge 13 as shown in FIG. 2. That is, the first edge 13 elastically supports the diaphragm group 11 with respect to the frame 3.

The first edge 13 is, for example, formed such that a surface of the inner circumference portion 13a is positioned in a substantially same plane as the surfaces of the first diaphragm 21 and the second diaphragm 22. Hence, in the speaker device according to the present Embodiment 1, since a flat surface formed by the first diaphragm 21, the second diaphragm 22, and the inner circumference portion 13a of the first edge 13 is vibrated, it is possible to emit a sound wave having a substantially identical phase in a comparatively broad range. The first edge 13 may be an elastic material such as a urethane foam and a rubber, and may also be the similar material as the above-described first diaphragm 21 and the second diaphragm 22. Furthermore, the second diaphragm 22 and the first edge 13 may be integrally formed with the similar material.

The driving member 12 is, as shown in FIG. 10 and FIG. 11, structured by integrally forming an inner circumference portion 31, a cone-shaped portion 32, the first groove portion 33, a ridge portion 34, the second groove portion 35, an inversed cone-shaped portion 36, a flat portion 37, and a folded portion 38. The driving member 12 drives the diaphragm group 11 by transmitting a driving force of a voice coil supporting part 15 to the diaphragm group 11 via the first groove portion 33, the ridge portion 34, the second groove portion 35, and the plurality of second connecting parts 36a (all of which will be described later). The materials of the driving member 12 include, for example, known materials such as a synthetic resin, a metal, and a paper. The driving member 12 is a substantially annular shape in a plan view.

The inner circumference portion 31 of the driving member 12 is, as shown in FIG. 2, fixed by an adhesive or the like to an outer circumference portion of the voice coil supporting part 15 having a substantially cylindrical shape in the vicinity of a front end (on the first diaphragm 21 side). As the material of the voice coil supporting part 15, for example, a metal material or a synthetic resin can be adopted. Specifically, for example, a metal such as aluminum or duralumin, or a material which is not air permeable such as a resin film such as polyimide can be adopted as a material of the voice coil supporting part 15. A plurality of air holes 15a are bored on a circumference surface of the voice coil supporting part 15. The plurality of air holes 15a are arranged at substantially the same interval in a circumferential direction and a height direction of the voice coil supporting part 15.

Additionally, in order to reinforce the joint strength in a joint portion between the voice coil supporting part 15 and the driving member 12, as shown in FIG. 2, a reinforcing member 18 is provided on the magnetic circuit 2 side of the joint portion between the voice coil supporting part 15 and the inner circumference portion 31 of the driving member 12. The reinforcing member 18 is a substantially annular shape. The reinforcing member 18 is formed by, for example, a known material such as a synthetic resin or a metal. Since the speaker device includes the reinforcing member 18, for example, the joint strength is comparatively high in the joint portion between the voice coil supporting part 15 and the driving member 12, and thus it is possible to emit a comparatively high sound wave. Furthermore, when the diaphragm group 11 and the driving member 12 are vibrated with a large amplitude, a large stress is exerted on the joint portion between the driving member 12 and the voice coil supporting part 15. Hence, the voice coil supporting part 15 is likely to be bent. However, it is possible to prevent the occurrence of a bending, since the voice coil supporting part 15 includes the reinforcing member 18.

A voice coil 16 is wound around an outer circumference face of the voice coil supporting part 15 in the vicinity of a rear end portion thereof (on the magnetic circuit 2 side) as shown in FIG. 2. A plurality of protruding portions (not shown) are formed in an inner circumference portion of the reinforcing member 18 in a circumferential manner and toward the voice coil supporting part 15, so as to form a predetermined interval with respect to the outer circumference face of the voice coil supporting part 15. A pair of lead lines, each of which is electrically connected to either end portion of the voice coil 16, pass between the protruding portions of the reinforcing member 18 and between the reinforcing member 18 and the voice coil supporting part 15, are pulled out in the vicinity of an upper end portion along the outer circumference portion of the voice coil supporting part 15, and are electrically connected to a pair of wires arranged between, for example, the driving member 12 and the diaphragm group 11. The pair of wires are, for example, lead lines which are formed by twisting a plurality of thin electric wires and are strong against bending, conductive lines subjected to a braiding process, or the like.

As shown in FIG. 10 and FIG. 11, the cone-shape portion (extending portion) 32 is formed continuously with the inner circumference portions 31 of the driving member 12. The cone-shape portion 32 is a substantially cone-shape extending toward the surface side (sound emission direction) from the inner circumference portion 31 to the first groove portion 33. A plurality of first connecting parts 32a are integrally formed in a radial direction of the cone-shaped portion 32 from a substantially center portion to a boundary portion with the first groove portion 33. In the present Embodiment 1, four (a plurality of) first connecting parts 32a are formed. Each of the first connecting parts 32a is a substantially fan shape in a plain view, the connecting parts 32a are separated from each other with a predetermined interval, and are formed in the positions where the connecting parts 32a opposing with respect to the center of the inner circumference portion 31 become substantially symmetric to each other. Each of the first connecting parts 32a supports, as a whole, the first diaphragm 21 by fixing a portion which is closer to an inner circumference than a step portion 21a and on a rear surface of the first diaphragm 21 by, for example, an adhesive or the like. In addition, the number of the above-described plurality of first connecting parts 32a to be formed may be an odd number (for example, five). With such a structure, it is possible to prevent the occurrence of a divided vibration (including a divided resonance) which occurs in the diaphragm group 11.

As in a conventional manner, in the driving member (drive cone) 12, in a case where the supporting part supporting the first diaphragm 21 is formed into a substantially annular shape, due to the material of the first diaphragm 21 (for example, an ABS resin or the like) or the limitation of a shape as a thin subwoofer (a thickness is comparatively small though a diameter is large), when the speaker device is driven, there is a possibility that a so-called “squeaking” (abnormal sound) phenomenon occurs where a vibration acceleration at a specific position of the first diaphragm 121 at a predetermined frequency becomes comparatively higher than a vibration acceleration at another point. However, in the present Embodiment 1, each of the first connecting parts 32a is provided in the cone-shaped portion 32 of the driving member, and is a shape divided into a plurality of portions in the circumferential direction. Thus, it is possible to make the vibration acceleration of the first diaphragm 21 close to the vibration acceleration of the second diaphragm 22. Therefore, it is possible to prevent the possibility that such a “squeaking” (abnormal sound) phenomenon occurs. In addition, the connecting members 32a may be substantially annular shapes. Even with such a structure, as in the case where the connecting parts 32a are divided into a plurality of shapes, it is possible to prevent the possibility of “squeaking” (abnormal sound) phenomenon. Additionally, by connecting the driving member 12 to the first diaphragm 21 via the first connecting parts 32a, it is possible to comparatively increase the rigidity of the first diaphragm 21. Therefore, it is possible to prevent the occurrence of a divided vibration (including a divided resonance) in the driving member 12. In addition, as shown in FIG. 10 and FIG. 11, it is possible to add a structure where wires pass between the adjacent first connecting parts 32a. Further, according to the present Embodiment 1, it is possible to obtain a speaker device having a reinforced structure as a whole, without forming a reinforcing portion such as ribs on the rear surface of the first diaphragm 21. Additionally, the structure of the speaker device is not limited to the present Embodiment 1, and can be appropriately changed by providing one or a plurality of reinforcing portions such as ribs extending in the radial direction or the circumference direction on the rear surface of the first diaphragm 21. In the case where the reinforcing portion is provided on the rear surface of the first diaphragm 21, it is possible to comparatively increase the rigidity of the first diaphragm 21.

In the cone-shaped portion 32, a plurality of air holes 32b are bored between each of the first connecting parts 32a so as to introduce the air inside the speaker device from the outside. In the present Embodiment 1, four air holes 32b are bored. Additionally, in the cone-shaped portion 32, a plurality of through holes 32c for arranging wires, which are not shown, are bored in two of the spaces between each of the first connecting parts 32a. In the present Embodiment 1, four through holes 32c are bored.

The first groove portion 33, the ridge portion 34, and the second groove portion 35 are sequentially formed from the cone-shaped portion 32 to the inversed cone-shape portion 36. Each of the first groove portion 33, the ridge portion 34, and the second groove portion 35 is a substantially annular shape in a plan view. As described above, when the first diaphragm 21 and the driving member 12 are assembled, the first groove portion 33, the ridge portion 34, and the second groove portion 35 are fixed to the protruding portion 22c, the groove portion 22f, and the protruding portion 22d of the second diaphragm 22 by an adhesive or the like, in the state where the first groove portion 33, the ridge portion 34, and the second groove portion 35 are fitted into the protruding portion 22c, the groove portion 22f, and the protruding portion 22d of the second diaphragm 22, respectively.

The inversed cone-shaped portion (inversed extending portion) 36 is formed continuously with the second groove portion 35. The inversed cone-shaped portion 36 is an inversed cone-shape extending toward the rear surface side (in the direction opposite to the sound emission direction) from the second groove portion 35 to the flat portion 37. A plurality of second connecting parts 36a are integrally formed from a substantially center portion to a boundary portion with the flat portion 37 in a radial direction of the inversed cone-shaped portion 36. In the present Embodiment 1, six second connecting parts 36a are formed. Each of the second connecting parts 36a is a substantially trapezoidal shape in a plan view and is separated from each other with a predetermined interval. The second connecting parts 36a are formed in the positions where portions opposing with respect to the center of the inner circumference portion 31 become substantially symmetric to each other.

Each of the second connecting parts 36a protrudes toward the sound emission direction, and supports the second diaphragm 22 in the rear surface side. Specifically, each of the second connecting members 36a supports by fitting into a part of the corresponding mountain portion 22ea and valley portion 22eb of the convex portion 22e formed on the rear surface of the second diaphragm 22. More specifically, a groove portion 36aa is formed at each top portion of each of the second connecting parts 36a. This groove portion 36aa is fitted into a part of the mountain portion 22ea and the valley portion 22eb formed in the rear surface of the second diaphragm 22, and the second diaphragm 22 and the driving member 12 are connected to each other. Additionally, ribs 36b are integrally formed along the radial direction in the substantially center, and on the inner circumference portion 31 side of each of the second connecting parts 36a. In addition, the case is shown where the second connecting parts 36a are discontinuous to each other. However, this is not the limitation. Similar to the outer shape of the convex portion 22e, each of the second connecting parts 36a may be an outer shape to form a substantially gear shape where each of the second connecting parts 36a are continuous to each other. As described above, in the speaker device according to the present Embodiment 1, the driving member 12 and the second diaphragm 22 are connected to each other by the second connecting parts 36a, the first groove portion 33, the ridge portion 34, and the second groove portion 35 of the driving member 12, and the driving member 12 supports the second diaphragm 22. Hence, the driving member 12 and the diaphragm group 11 are joined with a comparatively high joint strength, and the driving force of the voice coil 16 can be uniformly transmitted to a comparatively broad area of the second diaphragm 22 via the driving member 12.

Additionally, two through holes 36ca and 36cb are respectively bored on a line which passes through the center of the inner circumference portion 31 by interposing the inner circumference portion 31 therebetween and in the vicinity of the second groove portion 35 of the inversed cone-shaped portion 36. Furthermore, holding portions 36da and 36db for holding wires, which are not shown, are formed in the positions adjacent to the respective through holes 36ca and 36cb and in the vicinity of the flat portion 37 of the inversed cone-shaped portion 36.

In this manner, one of the pair of wires is held by a holding portion 37a, which will be described later, and the holding portion 36da, then it is arranged over the inversed cone-shaped portion 36, and is inserted from the through hole 36ca to the rear surface side of the first groove portion 33, the ridge portion 34, and the second groove portion 35. Then, it is pulled out from one of the through holes 32c adjacent to the through hole 36ca to the front surface side (the first diaphragm 21 side) of the driving member 12, and is further inserted into the other one of the through holes 32c. Thus, the wire is wired to the voice coil supporting part 15. Similarly, the other one of the pair of the wires is held by a holding portion 37b, which will be described later, and the holding portion 36db, then it is arranged over the inversed cone-shaped portion 36, and is inserted from the through hole 36cb to the rear surface side of the first groove portion 33, the ridge portion 34, and the second groove portion 35. Then, it is pulled out from one of the through holes 32c adjacent to the through hole 36cb to the front surface side (the first diaphragm 21 side) of the driving member 12, and is further inserted into the other one of the through holes 32c. Thus, the wire is wired to the voice coil supporting part 15.

In this manner, in the speaker device according to the present Embodiment 1, the wires circumvent the first groove portion 33, the ridge portion 34, and the second groove portion 35 of the driving member 12 to the rear side thereof. Thus, for example, it is possible to arrange the wires from the inner circumference portion to the outer circumference portion of the driving member 12 with a simple structure, without providing a groove portion for wiring on the first groove portion 33, the ridge portion 34, and the second groove portion 35. It is preferable that the diameters of the through holes 32c, 36ca, and 36cb be formed to be substantially the same as the diameter of the wire which is not shown. With the above-described structure, it is possible to reduce a decrease in air-tightness of the sealed space 17 of the speaker device. Furthermore, the gaps between the wires and the through holes 32c, 36ca, and 36cb may be filled with a synthetic resin or a conductive material in a state where the wires are inserted into the through holes 32c, 36ca, and 36cb. In this manner, it is possible to further reduce a decrease in air-tightness of the sealed space 17, and to maintain the air-tightness.

The flat portion 37 is formed continuously with the inversed cone-shaped portion 36. In the flat portion 37, the holding portions 37a and 37b for holding wires, which are not shown, are formed in the position in the vicinity of the holding portions 36da and 36db formed on the inversed cone-shaped portion 36. The folded portion 38 is formed continuously with the flat portion 37. The driving member 12 has a comparatively high rigidity, since the folded portion 38 is formed.

An inner circumference portion 14a of the second edge 14 is fixed to a rear surface of the flat portion 37 by an adhesive or the like, as shown in FIG. 2 and FIG. 5. The second edge 14 has an appropriate compliance (rigidity), and is not air permeable. The second edge 14 is structured by integrally forming the inner circumference portion 14a, a convex portion 14b, and an outer circumference portion 14c. The second edge 14 is a substantially annular shape in an entire plan view. Longitudinal sectional shapes of the inner circumference portion 14a and the outer circumference portion 14c are flat shape. On the other hand, a longitudinal sectional shape of the convex portion 14b is a substantially W-shape protruding toward the rear surface side (in the direction opposite to the sound emission direction). The convex portion 14b includes flexible deformation properties and a comparatively high rigidity, since the convex portion 14b is a substantially W-shape in a longitudinal sectional view. The outer circumference portion 14c is fixed, by an adhesive or the like, to a center flat portion 3e forming the frame 3, which will be described later. As described above, the driving member 12 is connected to the frame 3 via the second edge 14 as shown in FIG. 2. That is, the second edge 14 elastically supports the driving member 12 with respect to the frame 3. The second edge 14 may be made of the similar material as the above-described first diaphragm 21, the second diaphragm 22, the driving member 12, and the first edge 13, or may be made of a different material. In addition, the driving member 12 and the second edge 14 may be integrally formed with the same material.

Next, a description will be given of a structure of the magnetic circuit 2. The magnetic circuit 2 is an outer magnetic type which holds a magnet 42 between a yoke 41 and a plate 43 as shown in FIG. 2. In addition, in the present Embodiment 1, the case is shown where the outer magnetic type magnetic circuit is adopted. However, this is not the limitation, and an inner magnetic type magnetic circuit may be adopted.

As a material forming the yoke 41, for example, a metal such as a pure iron, an oxygen-free steel, and a silicon steel, and an alloy may be listed. However, the yoke 41 can be made of a known magnetic material. The yoke 41 is structured by integrally forming a tube portion 41a having a substantially cylindrical shape formed in a center portion and a flange portion 41b formed into a shape protruding from a bottom portion of the tube portion 41a toward the outside in the radial direction. A through hole 41aa is bored in the center portion of the tube portion 41a. A sheet-like dust-proof member 44 having an air-permeability is provided on an upper portion of the tube portion 41a. The outer diameter of the tube portion 41a is slightly smaller than the inner diameter of the voice coil supporting part 15. The tube portion 41a is loosely inserted into the inside of the voice coil supporting part 15. The flange portion 41b is a substantially annular shape in a plan view. Additionally, the magnet 42 is fixed to a surface (in the sound emission direction) of the flange portion 41b by, for example, an adhesive or the like.

The magnet 42 is made of, for example, a permanent magnet such as a rare earth magnet (for example, a neodymium magnet), a samarium-cobalt magnet, an alnico magnet, and a ferrite magnet. The magnet 42 is a substantially annular shape. As a material of the plate 43, for example, a pure iron, an oxygen-free steel, a silicon steel and the like may be listed. However, the plate 43 can be made of a known magnetic material. The plate 43 is a substantially annular shape. The inner diameter of the plate 43 is slightly larger than the outer diameter of the voice coil 16 which is wound around the outer circumference surface in the vicinity of a rear end portion of the voice coil supporting part 15.

The yoke 41, the magnet 42, and the plate 43 are formed in substantially concentric circle shapes, and are fixed by, for example, an adhesive or the like, such that the respective central axes in a thickness direction coincide with each other. Additionally, the magnetic circuit 2, which is formed by the yoke 41, the magnet 42, and the plate 43, is formed such that the outer diameter of the flange portion 41b of the yoke 41, the outer diameter of the magnet 42, and the outer diameter of the plate 43 are substantially the same. In the present Embodiment 1, the outer diameter of the magnet 42 is formed to be comparatively larger than the outer diameter of the flange portion 41b and the outer diameter of the plate 43. The outer diameter of the magnetic circuit 2 according to the present Embodiment 1 is, for example, the average value, the maximum value, or the minimum value of the outer diameters of the yoke 41, the magnet 42, the plate 43 and the like. Additionally, in the magnetic circuit 2, a magnetic gap is formed between the inner circumference portion of the plate 43 and the outer circumference portion of the tube portion 41a of the yoke 41. A substantially uniform magnetic flux density distribution is formed over an entire circumference of the magnetic gap.

The frame 3 is a substantially U-shape in a cross-sectional view where the diameter is increased from the lower portion to the upper portion as shown in FIG. 2. Specifically, in the frame 3, an opening 3a having a diameter smaller than the outer diameter of the magnetic circuit 2 is formed in the bottom portion, and a lower flat portion 3b is formed in the vicinity of the opening 3a. Additionally, a curved portion 3c is formed which is a curved shape in the sound emission direction and extends from the lower flat portion 3b toward the outside in the radial direction. An upper flat portion 3d is formed in an upper portion of the curved portion 3c. The outer circumference portion 13c of the first edge 13 is fixed to the upper flat portion 3d by, for example, an adhesive or the like. That is, the outer circumference portion of the diaphragm group 11 is supported by the upper flat portion 3d of the frame 3 via the first edge 13.

Further, in the frame 3, a middle flat portion 3e is formed in a substantially center and on a circumference face of the curved portion 3c. The outer circumference portion 14c of the second edge 14 is fixed to the middle flat portion 3e by, for example, an adhesive or the like. That is, the outer circumference portion of the driving member 12 is supported by the middle flat portion 3e of the frame 3 via the second edge 14. Additionally, in the frame 3 according to the present Embodiment 1, openings 3f for arranging connecting terminals which electrically connect the above-described wires to the outside are bored in the curved portion 3c between the middle flat portion 3e and the lower flat portion 3b. The opening portions 3f, not all of which are shown, are bored in the circumference direction with predetermined intervals.

The frame 3 is made of, for example, a ferrous metal, a non-ferrous metal, or an alloy of these, a synthetic resin or the like. The ferrous metal includes, for example, a pure iron, an oxygen-free steel, a silicon steel and the like. The non-ferrous metal includes, for example, aluminum, magnesium, zinc and the like. The synthetic resin may be made by adding, as a reinforcing filler, a glass fiber or a fibrillated thermotropic liquid crystal polyester resin to a thermoplastic resin such as a polyethylene terephthalate resin, an ABS (Acrylonitrile Butadiene Styrene) resin, and an olefin-series resin such as a polypropylene. The frame 3 is formed by squeeze forming of a ferrous metal, diecast molding of a non-ferrous metal or an alloy of these, or injection molding of a synthetic resin.

As shown in FIG. 2, a protection member 4 is mounted on an upper end portion of the frame 3. The protection member 4 is, for example, a substantially annular shape in a plan view, and is a convex shape in a cross-sectional view. A top portion of the protection member 4 is formed higher than the first edge 13, and includes a function of preventing a problem such as contacting of an obstacle to the first edge 13 or the diaphragm group 11.

In this manner, according to Embodiment 1 of the present invention, in order to make the vibration acceleration of the first diaphragm 21 and the vibration acceleration of the second diaphragm 22 close to each other, the driving member 12 and the first diaphragm 21 are connected via the first connecting parts 32a. As a result, it is possible to prevent the occurrence of the “squeaking” (abnormal sound) phenomenon based on the above-described difference between the vibration accelerations. Additionally, since the first connecting parts 32a support the first diaphragm 21, it is possible to comparatively increase the rigidity of the first diaphragm 21, and to prevent the occurrence of a divided vibration (including a divided resonance).

Further, according to Embodiment 1 of the present invention, the surfaces (in the sound emission direction) of the diaphragm group 11 are structured to form a substantially flat shape such that the surfaces are positioned on the substantially same plane. Here, the “flat shape” (also referred to as “tabular shape”) includes a shape having a somewhat uneven cross sectional surface, in addition to a literally flat shape. Specifically, when a convex cross-sectional surface is regarded as a “mountain” of a wave, and a concave cross-sectional surface, which is on either side of the convex cross-sectional surface, is regarded as a “valley” of the wave, it indicates a case where the length of a wavelength defined by the mountain and the valley is sufficiently shorter than the wavelength of a sound wave emitted from the speaker device, or a case where the difference in the height between the top portion of the convex cross-sectional shape of the diaphragm group 11 and the top portion of the concave cross-sectional shape is sufficiently small with respect to the wavelength of a sound wave emitted from the above-described speaker device. Furthermore, the diaphragm group 11 is regarded as the flat as long as the shape of the diaphragm group 11 makes the phase difference between sound waves comparatively small. Specifically, since the wavelength of a sound wave emitted from the speaker device for low frequency reproduction is comparatively long, the diaphragm group 11, having the above-described concave and convex cross-sectional surfaces, is regarded as the flat shape.

In this manner, the surfaces of the diaphragm group 11 are structured to form the substantially flat shape such that the surfaces (in the sound emission direction) are positioned on the substantially same plane. Thus, it is possible to make the phase difference between sound waves comparatively small, and to prevent the sound waves from interfering with each other (counteracting with each other). Therefore, it is possible to provide a good acoustic characteristic.

### Embodiment 2

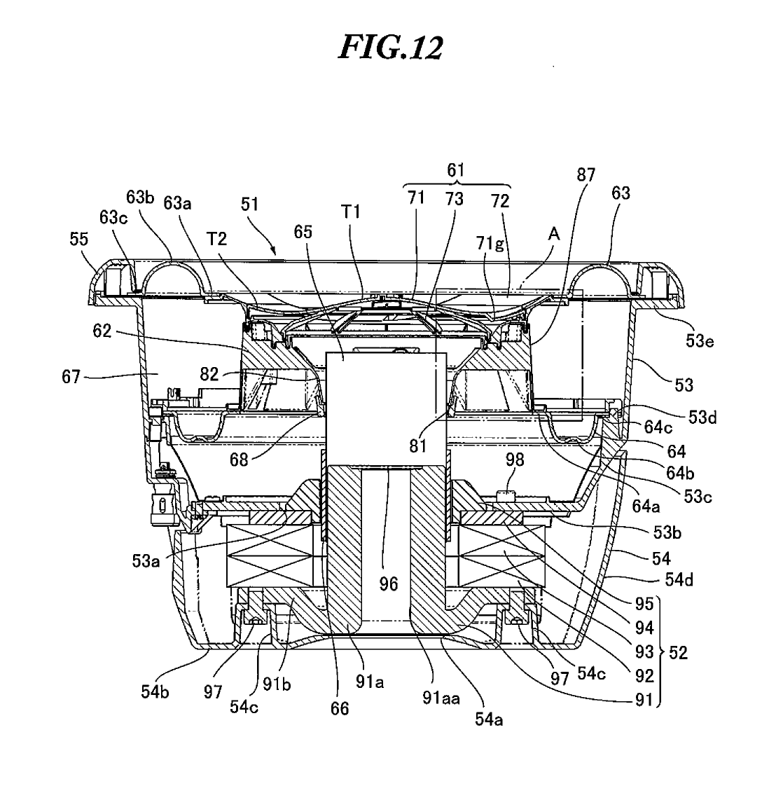

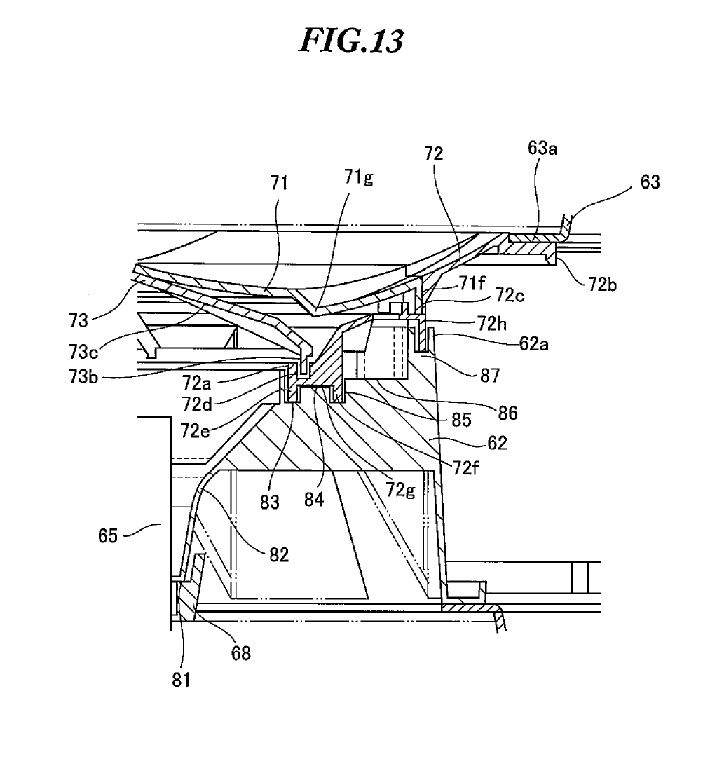

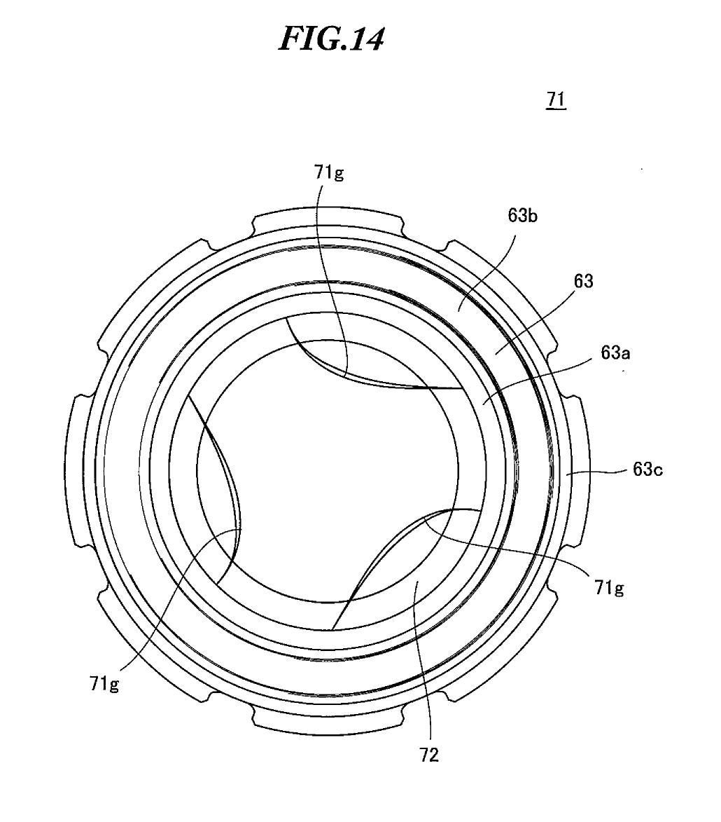

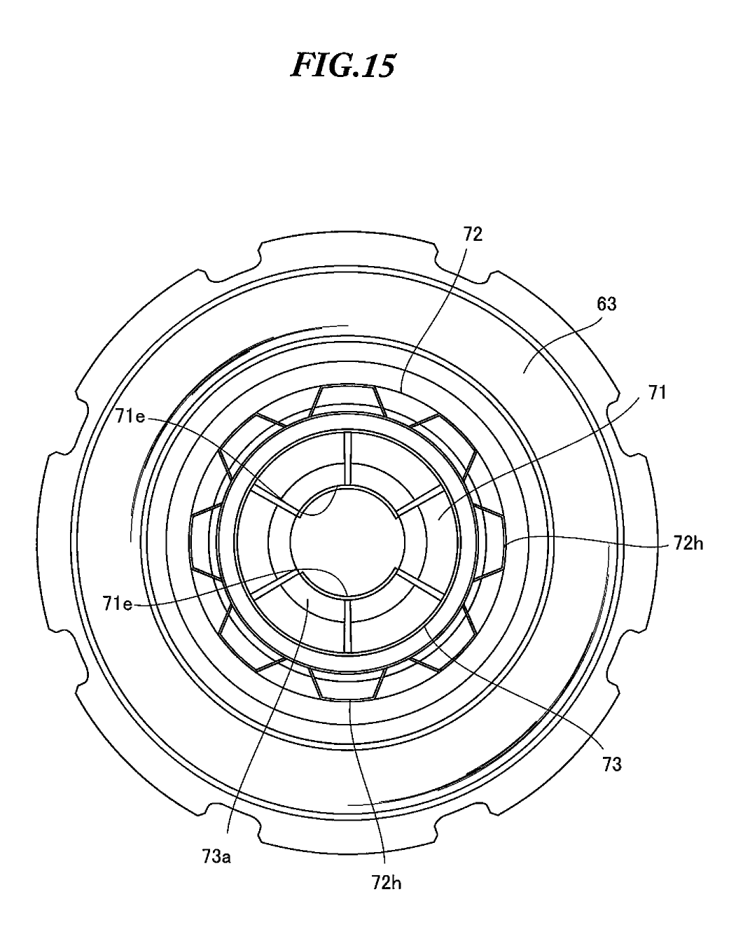

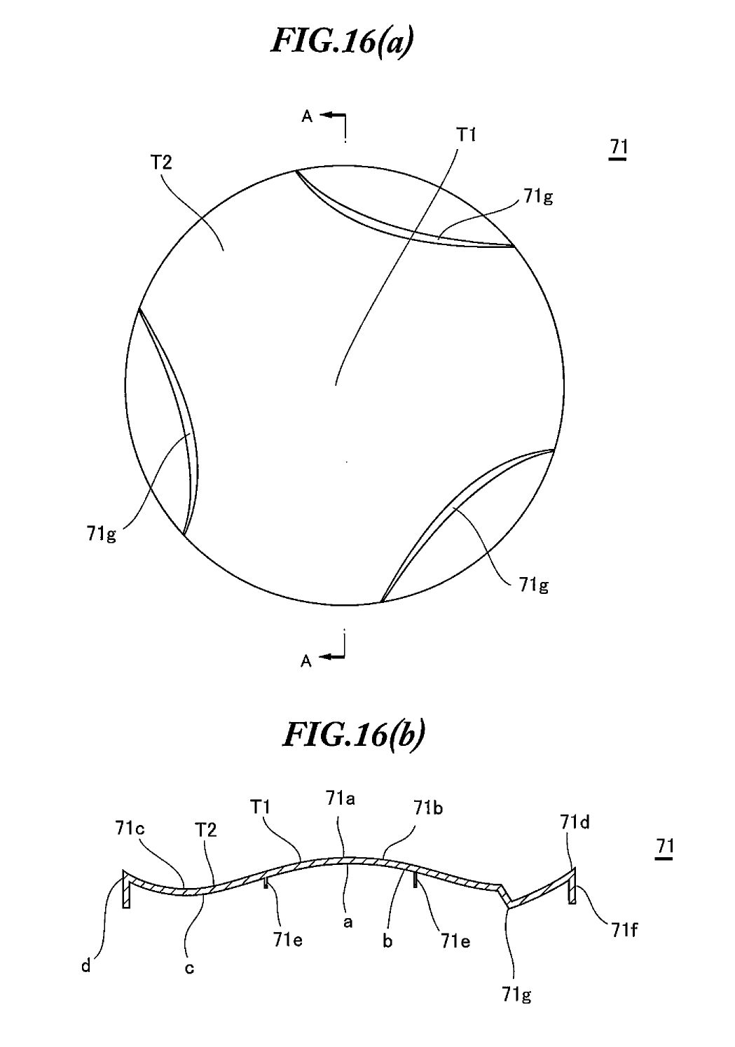

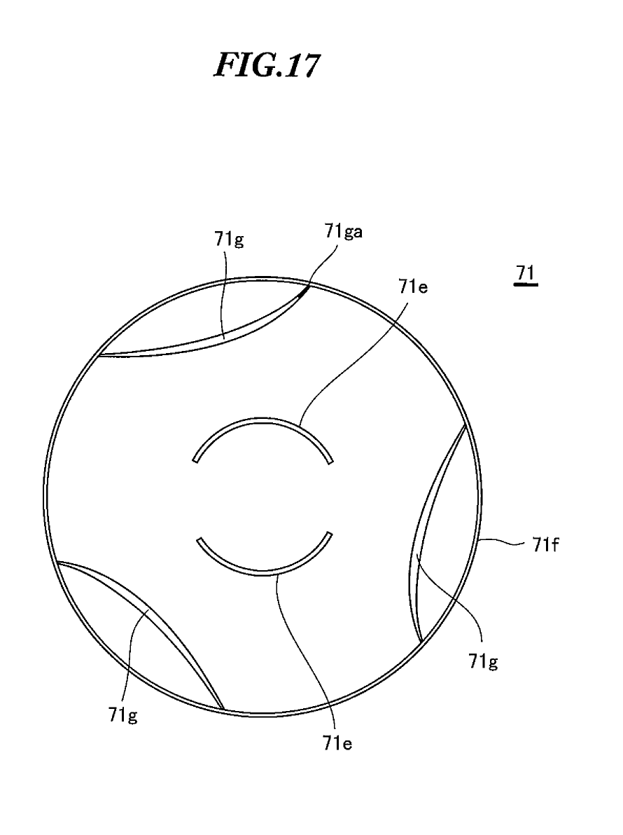

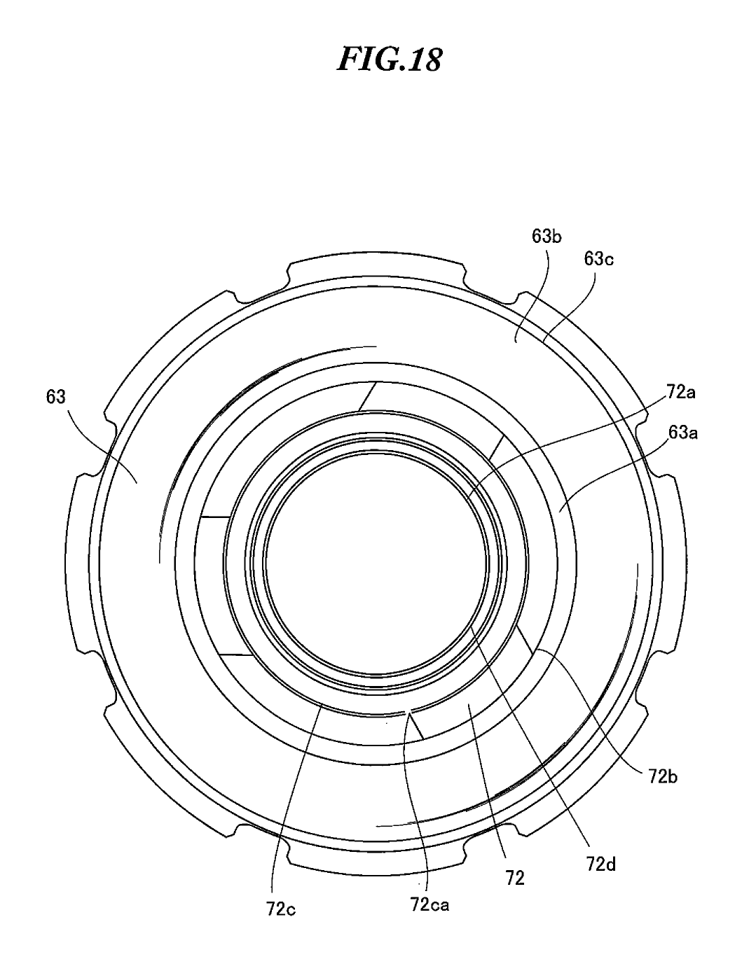

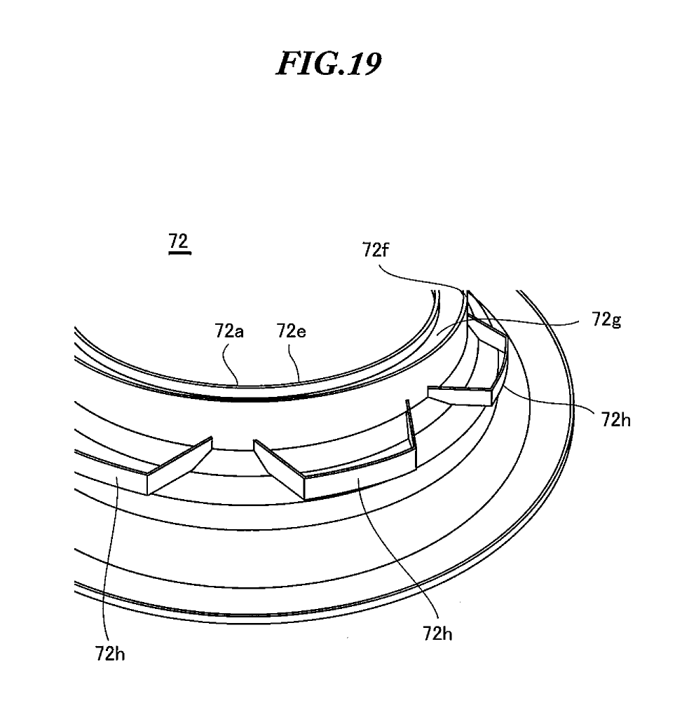

FIG. 12 is a cross-sectional view illustrating a structure of a speaker device according to Embodiment 2 of the present invention, FIG. 13 is an enlarged view of a part A of FIG. 12, FIG. 14 is a front view illustrating a state where a first edge 63 is mounted to the diaphragm group 61, and FIG. 15 is a rear view illustrating a state where the first edge 63 is mounted to the diaphragm group 61. Additionally, FIG. 16 are diagrams illustrating a structure of a first diaphragm 71, wherein (a) is a front view, and (b) is an A-A cross-sectional view of (a), FIG. 17 is a rear view illustrating the structure of the first diaphragm 71, FIG. 18 is a front view illustrating a state where the first edge 63 is mounted to a second diaphragm 72 which is a part of the diaphragm group 61, and FIG. 19 is a perspective view illustrating a rear side structure of the second diaphragm 72.

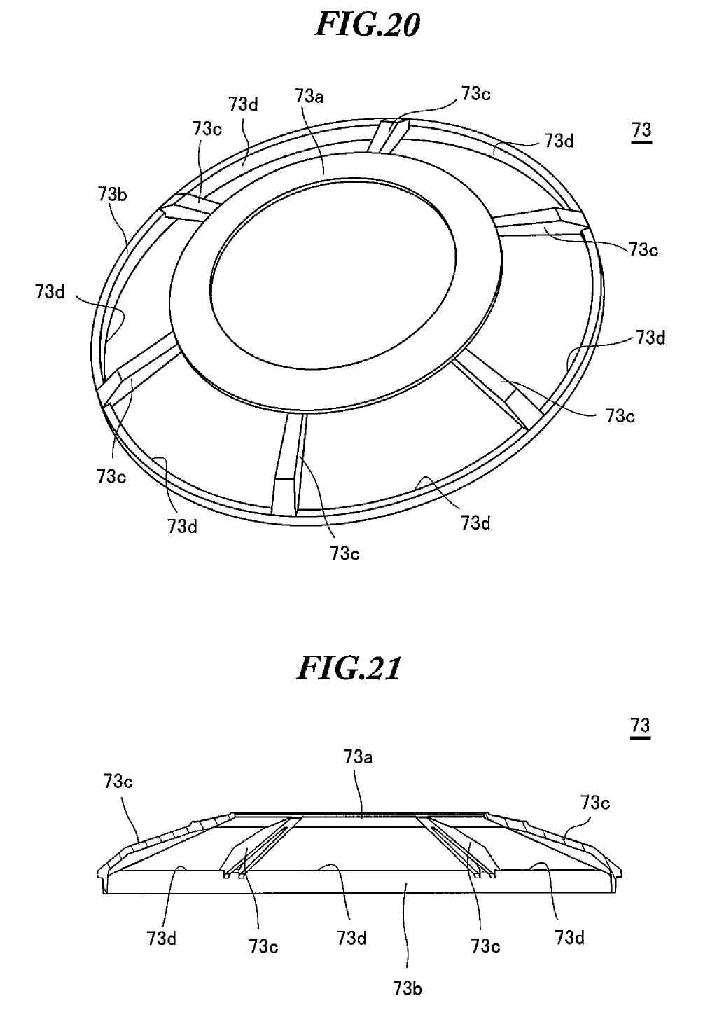

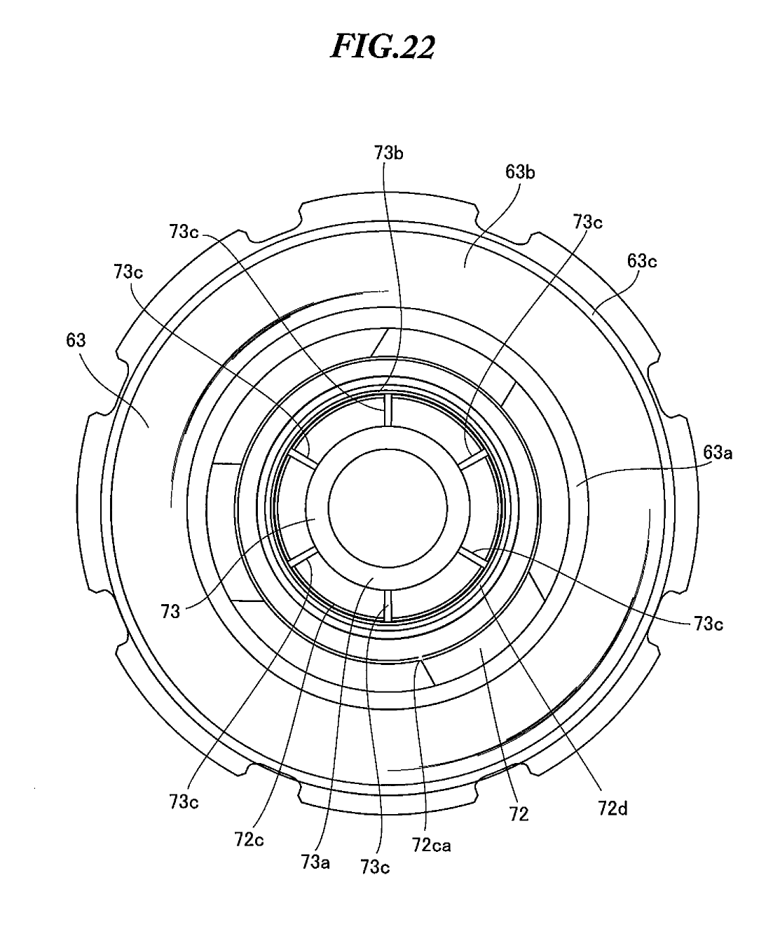

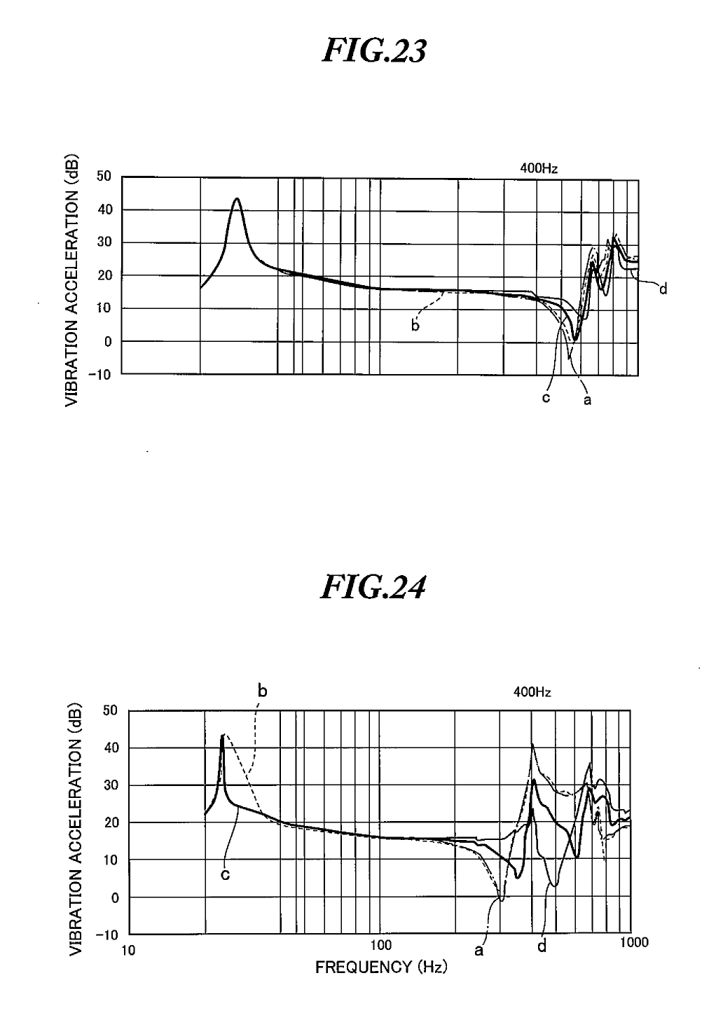

Further, FIG. 20 is a perspective view illustrating a structure of a connecting member 73, and FIG. 21 is a side view illustrating the structure of the connecting member 73. In addition, FIG. 22 is a front view illustrating a state where the connecting member 73 is placed on the second diaphragm 72 to which the first edge 63 is mounted. FIG. 23 is a graph illustrating, during driving of the speaker device according to Embodiment 2 of the present invention, an example of a characteristic of a vibration acceleration with respect to a frequency at each point of the first diaphragm 71 forming the speaker device. FIG. 24 is a graph illustrating, during driving of a conventional speaker device, an example of a characteristic of a vibration acceleration with respect to a frequency of a first diaphragm forming the speaker device.

The speaker device according to the present Embodiment 2 includes a vibrating body 51, a magnetic circuit 52, a first frame (speaker frame) 53, and a second frame (speaker frame) 54, and is especially preferably used for a low-frequency reproduction speaker, such as a subwoofer. The vibrating body 51 includes the diaphragm group 61, a driving member (drive cone) 62, the first edge 63, a second edge 64, a voice coil supporting part (voice coil bobbin) 65, and a voice coil 66. That is, the speaker device according to the present Embodiment 2 is a double-cone type where the vibrating body 51 includes the diaphragm group 61 and the driving member 62.

In this speaker device, as shown in FIG. 12, a sealed space 67 is formed which is surrounded by the first frame 53, the driving member 62, and the second diaphragm 72 which will be described later. A gas filled in the sealed space 67 is, for example, a gas such as the air, and is defined to be a predetermined pressure, for example, normal pressure (atmospheric pressure). That is, the speaker device having the structure as described above is a dumperless speaker device where the air in the sealed space 67 functions as an air spring (air dumper) to support the vibrating body 51. The volume of the sealed space 67 affects a spring constant, particularly, a stiffness. Hence, the speaker device according to the present Embodiment 2 defines the volume of the sealed space 67 to have a predetermined stiffness. Since the voice coil supporting part 65 is supported by the first frame 53 and the second frame 54 with an air dumper structure formed by the sealed space 67, the dumper function is not deteriorated even by a hard vibration. Therefore, it becomes possible to maintain a high durability in a high power speaker device. Thus, it is possible to obtain a structure suitable for a low frequency reproduction speaker, such as subwoofer.

Hereinafter, each element of the speaker device will be described with reference to the drawings. The diaphragm group 61 includes the first diaphragm (center cap) 71, the second diaphragm 72, and the connecting member 73. The first diaphragm 71, the second diaphragm 72, and the connecting member 73 are made of materials having a substantially equal acoustic characteristic determined by a Young's modulus E and a density ρ of a material (especially, a propagation speed (√/(E/ρ))). Specifically, the first diaphragm 71, the second diaphragm 72, and the connecting member 73 are made of, for example, a synthetic resin (as an example, a high-polymer material having a carbonate bond) or the like, among the above-described materials used as the materials of first diaphragm 21 and the second diaphragm 22. Additionally, in the prior art, there is a case where the propagation speed of a vibration propagated through a center cap is different from the propagation speed of a vibration propagated through a diaphragm, and an acoustic characteristic is deteriorated. Therefore, with the structure of the speaker device according to the present Embodiment 2, for example, it is possible to prevent the occurrence of the “squeaking” (abnormal sound) phenomenon caused by the difference between the propagation speeds.

The diaphragm group 61 is a substantially circular shape in a plan view in a state where the first diaphragm 71 and the second diaphragm 72 are fixed to each other by an adhesive or the like as shown in FIG. 12 and FIG. 14. Additionally, the diaphragm group 61 in the fixed state forms a continuously curved face which includes a convex cross-sectional portion T1 in a center portion and a concave cross-sectional portion T2 in a periphery portion. In this manner, since a longitudinal sectional shape of the diaphragm group 61 includes the convex cross-sectional portion T1 and the concave cross-sectional portion T2, the depth of a vibration face is reduced. Thus, it is possible to reduce the phase difference between a sound wave emitted from the convex cross-sectional portion T1 and a sound wave emitted from the concave cross-sectional portion T2. On this occasion, by reducing the difference in the depth between the convex cross-sectional portion T1 and concave cross-sectional portion T2, it is possible to eliminate the problem of the phase difference in a large diameter diaphragm as much as possible that the sound quality of the speaker device is deteriorated due to an attenuation or an undesired swell of sound, which is caused by an interference due to the phase difference between a sound wave emitted from the center portion of the diaphragm and a sound wave emitted from the periphery portion thereof.

Additionally, since the diaphragm group 61 forms the continuously curved face including the center convex cross-sectional portion T1 and the circumferential concave cross-sectional portion T2, the driving force exerted from the voice coil supporting part 65 to the diaphragm group 61 is substantially equally exerted on the diaphragm group 61 forming the continuous curve surface which is axisymmetric with respect to the center. The vibrating body 51 which can prevent the occurrence of a divided vibration, as in the cone-shaped and the dome-shaped, is formed with the continuously curved face.

In addition, since the diaphragm group 61 is the continuously curved face, it does not include a conventional discontinuous bent portion. Therefore, it is possible to prevent the stress from being concentrated on the vibrating body 51 even at the time of a high power output with a large amplitude. Hence, it is possible to obtain the vibrating body 51 having a comparatively large durability. Further, since the formation of a bent portion on a surface of the diaphragm group 61 is avoided as much as possible, dust or the like is hardly accumulated. Hence, it is possible to maintain a good vibration characteristic of the diaphragm group 61, and to obtain the vibrating body 51 having a good appearance. In addition, the continuously curved face of the diaphragm group 61 makes it impossible to recognize the presence of the first diaphragm 71, it is possible to obtain the vibrating body 51 having a good appearance, and to prevent dust or the like from entering in the voice coil supporting part 65, the magnetic circuit 52 and the like by the first diaphragm 71. Consequently, it is possible to maintain the operations of the voice coil supporting part 65, the magnetic circuit 52 and the like in good conditions.

The first diaphragm 71 is a substantially disc shape in a plan view as shown in FIG. 16(a). A longitudinal sectional shape of the first diaphragm 71 is a curved line shape where a top portion 71a, an inclined portion 71b, a bottom portion 71c, and an outer circumference portion 71d are smoothly continued as shown in FIG. 16(b). In the present Embodiment 2, the convex cross-sectional portion T1 and the concave cross-sectional portion T2 are formed in the surface of the first diaphragm 71. Hence, the above-described problem of the phase difference between the emitted sound waves is solved, and the first diaphragm 71 itself is reinforced. When the vibrating body 51 is strongly vibrated in order to reproduce loud sound, the air resistance acts on the first diaphragm 71, which results in a deformation such as a dent. Due to the deformation, it becomes difficult to reproduce sound waves having the same phase, which leads to a deterioration of the sound quality. Additionally, the first diaphragm 71 itself is vibrated, and the so-called “squeaking” (abnormal sound) phenomenon may occur. In order to prevent this, the convex cross-sectional portion T1 and the concave cross-sectional portion T2 are formed in the surface of the first diaphragm 71 itself so as to reinforce the first diaphragm 71. According to this, the deformation and the vibration of the first diaphragm 71 can be prevented. In this manner, it is possible to prevent a vibration and a deformation of the first diaphragm 71. Consequently, the sound quality is improved, and the occurrence of the abnormal sound is prevented.

A pair of locking protrusions 71e are integrally formed in a substantially center and on the rear surface of the first diaphragm 71 as shown in FIG. 16(b) and FIG. 17. Each of the pair of the locking protrusions 71e is a substantially arc shape. The pair of the locking protrusions 71e oppose to each other across the center of the first diaphragm 71. The pair of the locking protrusion 71e are, as shown in FIG. 15, engaged with an inner circumference portion of an inner circumference portion 73a forming the connecting member 73, and the first diaphragm 71 is locked. Therefore, by applying an adhesive to one or both of the inner circumference portion of the inner circumference portion 73a and the pair of the locking protrusions 71e, and thereafter engaging the pair of the locking protrusions 71e with the inner circumference portion of the inner circumference portion 73a, the connecting member 73 supports the first diaphragm 71.

Additionally, as shown in FIG. 16(b) and FIG. 17, an edge portion 71f which hangs substantially vertically is integrally formed in the outer circumference portion 71d and on the rear surface of the first diaphragm 71. The edge portion 71f is, as shown in FIG. 13, fitted into a first groove portion 72c (refer to FIG. 18) which is a substantially annular shape and is formed at a predetermined distance from an inner circumference portion 72a to the outer circumference portion 72b of the second diaphragm 72, and the first diaphragm 71 is locked. Therefore, by applying an adhesive to one or both of the edge portion 71f and the first groove portion 72c, and thereafter engaging the edge portion 71f with the first groove portion 72c, the second diaphragm 72 supports the first diaphragm 71.

Further, a plurality of surface shape portions 71g are formed in the surface of the first diaphragm 71 as shown in FIG. 13, FIG. 14, FIG. 16, FIG. 17 and the like. In the present Embodiment 2, three surface shape portions 71g are formed. It is possible to comparatively increase the rigidity by forming these surface shape portions 71g into a continuous shape which continues from the first diaphragm 71 to the second diaphragm 72. In addition, it is possible to improve the design by covering the boundary between the first diaphragm 71 and the second diaphragm 72. These surface shape portions 71g are formed to include a reinforcing function with respect to an external force of a vibration which acts concentrically. Further, as shown in FIG. 17, a locking protrusion 71ga is integrally formed on a boundary portion with the edge portion 71f on a rear surface of one of the surface shape portions 71g. When the first diaphragm 71 is mounted to the second diaphragm 72, the locking protrusion 71ga is engaged with a notch portion 72ca (refer to FIG. 18) formed in the first groove portion 72c, and is locked so as to prevent a rotation of the first diaphragm 71 with respect to the second diaphragm 72. Hence, it is possible to form the surface shape portions 71g of the first diaphragm 71 into the continuous shapes which continue from the first diaphragm 71 to the second diaphragm 72.

On the other hand, the second diaphragm 72 is a substantially annular shape as shown in FIG. 18. The inner diameter of the inner circumference portion 72a of the second diaphragm 72 is formed smaller than the outer diameter of the outer circumference portion 71d of the first diaphragm 71 (refer to FIG. 16(a)). A second groove portion 72d into which the connecting member 73 is fitted is formed to contact with the inner circumference portion 72a of the second diaphragm 72. The above-described first groove portion 72c is formed in a step portion which is raised to the surface (in the sound emission direction) side, and is spaced apart from the inner circumference portion 72a to the outer circumference portion 72b of the second diaphragm 72. The first groove portion 72c has a substantially annular shape. The first groove portion 72c supports the outer circumference portion 71d of the first diaphragm 71 so that the surface of the first diaphragm 71 and the surface of the second diaphragm 72 form a continuous surface in the vibrating body 51.

As shown in FIG. 19, two protruding portions 72e and the 72f, having annular shapes with different diameters and projecting toward the direction opposite to the sound emission direction, are formed in the inner circumference portion and on a rear surface of the second diaphragm 72. The protruding portion 72e is formed in the innermost circumference of the second diaphragm 72, and the protruding portion 72f is formed closer to an outer circumference with a predetermined distance from the protruding portion 72e. The width of the protruding portion 72e is formed, for example, substantially equal to the width of the protruding portion 72f. As shown in FIG. 12 and FIG. 13, when the second diaphragm 72 and the driving member 62 are assembled, these protruding portions 72e and 72f are fitted into a first groove portion 83 and a second groove portion 85 formed in the driving member 62, and a ridge portion 84 formed in the driving member 62 is fitted into and bonded to, by an adhesive or the like, a groove portion 72g between the protruding portion 72e and the protruding portion 72f, and they are fixed by an adhesive or the like. As described above, a joint is made by an adhesive or the like in the condition where the protruding portions 72e and 72f of the second diaphragm 72 are fitted into the first groove portion 83 and the second groove portion 85 of the driving member 62, respectively, and the ridge portion 84 of the driving member 62 is fitted into the groove portion 72g of the second diaphragm 72. Therefore, a comparatively large joint strength is obtained.

As shown in FIG. 19, eight convex portions 72h, having substantially trapezoidal shapes in a plan view and protruding in the direction opposite to the sound emission side, are formed in an outer circumference of the protruding portion 72f and on the rear surface of the second diaphragm 72. As shown in FIG. 13, when the second diaphragm 72 and the driving member 62 are assembled, all or a part of the convex portions 72h is fitted into and fixed to, by an adhesive or the like, eight connecting parts 87 formed in the driving member 62. In this manner, the above-described convex portions 72h are connected to the corresponding connecting parts 87 formed in the driving member 62, and the second diaphragm 72 is supported by the driving member 62.

In the speaker device according to the present Embodiment 2, the convex portions 72h of the second diaphragm 72 are supported by the connecting parts 87 formed in the driving member 62. Thus, for example, compared with a case where the second diaphragm 72 having a simple flat shape where the convex portions 72h are not formed is supported by the connecting parts 87, the second diaphragm 72 has a comparatively large rigidity, and a distortion of the second diaphragm 72 is reduced when a driving force is transmitted from the driving member 62 to the second diaphragm 72. Therefore, it is possible to transmit the driving force with a comparatively high efficiency.

An inner circumference portion 63a of the first edge 63 is fixed to, by an adhesive or the like, the outer circumference portion of the second diaphragm 72 as shown in FIG. 12, FIG. 14 and the like. The first edge 63 has an appropriate compliance (rigidity), and is little air permeable. The first edge 63 is structured by integrally forming the inner circumference portion 63a, the convex portion 63b, and the outer circumference portion 63c. The first edge 63 is a substantially annular shape in an entire plan view. Longitudinal sectional shapes of the inner circumference portion 63a and the outer circumference portion 63c are flat shapes. On the other hand, a longitudinal sectional shape of the convex portion 63b is a substantially roll shape protruding toward the surface side (sound emission direction). As shown in FIG. 12, the outer circumference portion 63c is fixed, by an adhesive or the like, to an upper flat portion 53e of the first frame 53, which will be described later. As described above, the diaphragm group 61 is connected to the first frame 53 via the first edge 63 as shown in FIG. 12. That is, the first edge 63 elastically supports the diaphragm group 61 with respect to the first frame 53. The first edge 63 is made of, for example, the similar material as the above-described first edge 13.

As shown in FIG. 20 and FIG. 21, the connecting member 73 is a substantially concentric shape in a plan view, and is structured by connecting the inner circumference portion 73a and an outer circumference portion 73b with a plurality of leg portions 73c. In the present Embodiment 2, six leg portions 73c are formed. An opening 73d is formed between the adjacent leg portions 73c. As shown in FIG. 22, since the outer circumference portion 73b is fitted into the second groove portion 72d of the second diaphragm 72, the connecting member 73 is supported by the second diaphragm 72. Additionally, in the state where the connecting member 73 is supported by the second diaphragm 72, since the pair of the locking protrusions 71e of the first diaphragm 71 are engaged with the inner circumference portion of the inner circumference portion 73a of the connecting member 73, the connecting member 73 supports the first diaphragm 71.

As shown in FIG. 13, the driving member 62 is structured by integrally forming an inner circumference portion 81, a cone-shape portion 82, the first groove portion 83, the ridge portion 84, the second groove portion 85, a flat portion 86, and the connecting parts 87. The driving member 62 drives the diaphragm group 61 by transmitting a driving force of the voice coil supporting part 65 to the diaphragm group 61 via the first groove portion 83, the ridge portion 84, the second groove portion 85, and the plurality of connecting parts 87 (all of which will be described later). A known material is listed for the driving member 62, for example, such as a synthetic resin, a metal, and a paper. The driving member 62 is a substantially annular shape in a plan view.

As shown in FIG. 12 and FIG. 13, an outer circumference surface of the voice coil supporting part 65 having a substantially cylindrical shape is fixed to the inner circumference portion 81 of the driving member 62 by an adhesive or the like. The voice coil supporting part 65 is made of, for example, the similar material with the above-described voice coil supporting part 15.

Additionally, in order to increase the joint strength in a joint portion between the voice coil supporting part 65 and the driving member 62, as shown in FIG. 13, a reinforcing member 68 is provided closer to the magnetic circuit 52 than the joint portion between the voice coil supporting part 65 and the inner circumference portion 81 of the driving member 62. The reinforcing member 68 is a substantially annular shape. The reinforcing member 68 is formed by, for example, a known material such as a synthetic resin and a metal. Since the speaker device includes the reinforcing member 68, for example, the joint portion between the voice coil supporting part 65 and the driving member 62 has a comparatively high joint strength. Thus, it is possible to emit a comparatively loud sound wave. In addition, when the diaphragm group 61 and the driving member 62 are vibrated with a large amplitude, a large stress is exerted on the joint portion between the driving member 62 and the voice coil supporting part 65, and the voice coil supporting part 65 is likely to be bent. However, it is possible to prevent the occurrence of a bending, since the voice coil supporting part 65 includes the reinforcing member 68.

The voice coil 66 is wound around the outer circumference face in the vicinity of a rear end portion (the magnetic circuit 52 side) of the voice coil supporting part 65 as shown in FIG. 12. In the reinforcing member 68, as in the above-described reinforcing member 18, a plurality of protruding portions are formed in a circumferential manner toward the voice coil supporting part 65 in the inner circumference portion of the reinforcing member 68, so as to form a predetermined interval with respect to the outer circumference surface of the voice coil supporting part 65 (not shown). A pair of lead lines, each of which is electrically connected to either end of the voice coil 66, pass between the protruding portions of the reinforcing member 68 and between the reinforcing member 68 and the voice coil supporting part 65, are pulled out in the vicinity of an upper end along the outer circumference portion of the voice coil supporting part 65, and are electrically connected to a pair of wires arranged between, for example, the driving member 62 and the diaphragm group 61. The pair of wires are, for example, lead lines which are formed by twisting a plurality of thin electric wires and are strong against bending, conductive lines subjected to a braiding process, or the like.

The cone-shaped portion (extending portion) 82 is formed continuously with the inner circumference portion 81 of the driving member 62. The cone-shaped portion 82 is a substantially cone-shape extending toward the surface side (sound emission direction) from the inner circumference portion 81 to the first groove portion 83.

The first groove portion 83, the ridge portion 84, and the second groove portion 85 are sequentially formed from the cone-shaped portion 82 to the flat portion 86. Each of the first groove portion 83, the ridge portion 84, and the second groove portion 85 is a substantially annular shape in a plan view. When the second diaphragm 72 and the driving member 62 are assembled as described above, the first groove portion 83, the ridge portion 84, and the second groove portion 85 are joined, by an adhesive or the like, to the protruding portions 72e, the groove portion 72g, and the protruding portion 72f of the second diaphragm 72, respectively, in the state where the first groove portion 83, the ridge portion 84, and the second groove portion 85 are fitted into the protruding portions 72e, the groove portion 72g, and the protruding portion 72f of the second diaphragm 72, respectively.

As shown in FIG. 12, the flat portion 86 is formed continuously with the second groove portion 85. The plurality of the connecting parts 87 are integrally formed on an outer circumference portion of the flat portion 86. Although eight (an even number of) connecting parts 87 are formed in the present Embodiment 2, only one connecting part 87 is shown in FIG. 13. The connecting parts 87 are separated from each other with a predetermined distance, and are formed in the positions where the connecting parts 87 opposing with respect to the center of the inner circumference portion 81 become substantially symmetric to each other. In addition, the number of the above-described plurality of connecting parts 87 may be an odd number (for example, nine). With such a structure, it is possible to prevent the occurrence of a divided vibration (including a divided resonance) which occurs in the diaphragm group 61.

Each of the connecting parts 87 projects in the sound emission direction and supports a rear surface side of the second diaphragm 72. Specifically, each of the connecting parts 87 is fitted into all or a part of the convex portions 72h formed on the rear surface of the second diaphragm 72 to support. As described above, in the speaker device according to the present Embodiment 2, the driving member 62 and the second diaphragm 72 are connected to each other by the connecting parts 87, the first groove portion 83, the ridge portion 84, and the second groove portion 85 of the driving member 62, and the driving member 62 supports the second diaphragm 72. Hence, the driving member 62 and the diaphragm group 61 are joined with a comparatively large joint strength. Thus, it is possible to uniformly transmit a driving force of the voice coil 66 to a comparatively large area of the second diaphragm 72 via the driving member 62.

As shown FIG. 12, an inner circumference portion 64a of the second edge 64 is fixed, by an adhesive or the like, to the rear surface and the outer surface portion of the driving member 62. The second edge 64 has an appropriate compliance (rigidity), and is not air permeable. The second edge 64 is structured by integrally forming the inner circumference portion 64a, a convex portion 64b, and an outer circumference portion 64c. The second edge 64 is a substantially annular shape in an entire plan view. Longitudinal sectional shapes of the inner circumference portion 64a and the outer circumference portion 64c are flat shapes. On the other hand, a longitudinal sectional shape of the convex portion 64b is a substantially W-shape protruding toward the rear surface side (the direction opposite to the sound emission direction). Since the convex portion 64b is a substantially W-shape in a longitudinal sectional view, the convex portion 64b includes flexible deformation properties and a comparatively high rigidity. The outer circumference portion 64c is fixed, by an adhesive or the like, to a center flat portion 53d forming the first frame 53, which will be described later. As described above, the driving member 62 is connected to the frame 53 via the second edge 64 as shown in FIG. 12. That is, the second edge 64 elastically supports the driving member 62 with respect to the frame 53. The second edge 64 may be made of the similar material to the above-described first diaphragm 71, the second diaphragm 72, the driving member 62, and the first edge 63, or may be made of a different material. In addition, the driving member 62 and the second edge 64 may be integrally formed with the same material.

Next, a description will be given of a structure of the magnetic circuit 52. The magnetic circuit 52 is an outer magnetic type which holds magnets 92 and 93 between a yoke 91 and plates 94 and 95 as shown in FIG. 12. In addition, in the present Embodiment 2, the case is shown where the outer magnetic type magnetic circuit is adopted. However, this is not the limitation, and an inner magnetic type magnetic circuit may be adopted.

The yoke 91 is made of, for example, the same material as the above described yoke 41. The yoke 91 is formed in a center portion, and is structured by integrally forming a tube portion 91a having a substantially cylindrical shape, and a flange portion 91b formed into a shape protruding from a bottom portion of the tube portion 91a toward the outside in the radial direction. A through hole 91aa is bored in the center portion of the tube portion 91a. A sheet-like dust-proof member 96 having an air-permeability is provided on an upper portion of the tube portion 91a. The outer diameter of the tube portion 91a is slightly smaller than the inner diameter of the voice coil supporting part 65. The tube portion 91a is loosely inserted into the inside of the voice coil supporting part 65. The flange portion 91b is a substantially annular shape in a plan view. Additionally, the magnets 92 and 93 are sequentially fixed to a surface (in the sound emission direction) of the flange portion 91b by, for example, an adhesive or the like.

The magnets 92 and 93 are made of, for example, the same material as the above described magnet 42. Both of the magnets 92 and 93 are substantially annular shapes and substantially the same shape. The magnets 92 and 93 are stacked for the reason described below. That is, in order to vibrate the diaphragm group 61 with a large amplitude, a comparatively large driving force is required. Therefore, an electromagnetic force exerted on the voice coil 66 is comparatively increased by providing and stacking a plurality of number magnets, rather than providing only one magnet. In addition, the magnetization directions of the magnets 92 and 93 are substantially the same direction. Further, since the plurality of magnets are provided, it is possible to comparatively increase the amplitude of the voice coil 66, while avoiding the voice coil 66 from contacting with the bottom portion of the tube portion 91a forming the yoke 91.

The plates 94 and the plate 95 are made of, for example, the same material as the above-described plate 43. The plate 94 is a substantially annular shape. On the other hand, the plate 95 is a substantially prefix cone ring shape. The inner diameter of the plate 95 is slightly larger than the outer diameter of the voice coil 66 which is wound around the outer circumference surface in the vicinity of a rear end portion of the voice coil supporting part 65.

The yoke 91, the magnets 92 and 93, and the plates 94 and 95 are formed into substantially concentric shapes, and are fastened to the first frame 53 and the second frame 54 with, for example, fastening members 97 and 98 and the like, such that the respective central axes in the thickness direction coincide with each other. In addition, the magnetic circuit 52, structured by the yoke 91, the magnets 92 and 93, and the plates 94 and 95, is formed such that the outer diameter of the flange portion 91b of the yoke 91, the outer diameters of the magnets 92 and 93, and the outer diameter of the plate 94 become substantially the same. In the present Embodiment 2, the outer diameters of the magnets 92 and 93 are formed comparatively larger than the outer diameter of the flange portion 91b and the outer diameter of the plate 94. The outer diameter of the magnetic circuit 52 according to the present Embodiment 2 is, for example, the average value, the maximum value, or the minimum value of the outer diameters of the yoke 91, the magnets 92 and 93, the plate 94 and the like. Further, in the magnetic circuit 52, a magnetic gap is formed between the inner circumference portion of the plate 95 and the outer circumference portion of the tube portion 91a of the yoke 91. A substantially uniform magnetic flux density distribution is formed over an entire circumference of the magnetic gap.

The first frame 53 is a substantially U-shape in a cross-sectional view where the diameter is increased from the lower portion to the upper portion as shown in FIG. 12. Specifically, in the first frame 53, an opening 53a having the inner diameter larger than the outer diameter of the plate 95 is formed in the bottom portion, and a lower flat portion 53b is formed in the vicinity of the opening 53a. The magnetic circuit 52 is fastened to the lower flat portion 53b with the fastening member 98.

Additionally, curved portion 53c is formed which extends from the lower flat portion 53b to the outside in the radial direction and is a shape curved in the sound emission direction. The upper flat portion 53e is formed in an upper portion of the curved portion 53c. The outer circumference portion 63c of the first edge 63 is fixed to the upper flat portion 53e by, for example, an adhesive or the like. That is, the outer circumference portion of the diaphragm group 61 is supported by the upper flat portion 53e of the first frame 53 via the first edge 63.

Further, in the frame 53, a middle flat portion 53d is formed in a substantially center and on a circumference face of the curved portion 53c. The outer circumference portion 64c of the second edge 64 is fixed to the middle flat portion 53d by, for example, an adhesive or the like. That is, the outer circumference portion of the driving member 62 is supported by the middle flat portion 53e of the first frame 53 via the second edge 64. As shown in FIG. 12, a protection member 55 is mounted on an upper end portion of the frame 53. The protection member 55 is, for example, a substantially annular shape in a plan view, and is a convex shape in a cross-sectional view. A top portion of the protection member 55 is formed higher than the first edge 63, and includes a function of preventing a problem such as contacting of an obstacle to the first edge 63 or the diaphragm group 61.

On the other hand, the second frame 54 is a substantially U-shape in a cross-sectional view where the diameter is increased from the lower portion to the upper portion as shown in FIG. 12. Specifically, in the second frame 54, an opening 54a having the inner diameter substantially equal to the outer diameter of the tube portion 91a of the yoke 91 is formed in the bottom portion, and a lower flat portion 54b is formed in the vicinity of the opening 54a. A plurality of closed-bottom holes 54c for fastening the magnetic circuit 52 with the fastening member 97 are bored in the lower flat portion 54b.

Additionally, a curved portion 54b is formed which is a curved shape in the sound emission direction and extends from the lower flat portion 54b toward the outside in the radial direction. The frames 53 and 54 are made of, for example, the same material as the above-described frame 3. The first frame 53 and the second frame 54 are connected to each other via the magnetic circuit 52.

In this manner, according to the present Embodiment 2 of the present invention, in the speaker device including the first diaphragm 71 and the second diaphragm 72, the rear center of the first diaphragm 71 is supported by the connecting member 73, and the outer circumference portion of the first diaphragm 71 is supported by the second diaphragm 72. Additionally, the first diaphragm 71, the second diaphragm 72, and the connecting member 73 are made of the materials having similar acoustic characteristics and are fixed to each other. Therefore, it is possible to prevent the occurrence of the so-called “squeaking” (abnormal sound) phenomenon in the second diaphragm 72 where a peak occurs in the vicinity of 400 Hz.

Here, FIG. 23 shows, during driving of the speaker device according to the present Embodiment 2 of the present invention, an example of a characteristic of a vibration acceleration with respect to a frequency at each point of the first diaphragm 71 forming the speaker device. In FIG. 23, a curve a is a characteristic curve with respect to an apex of the first diaphragm 71 shown in FIG. 16(b), a curve b is a characteristic curve with respect to a curved point of the first diaphragm 71 shown in FIG. 16(b), a curve c is a characteristic curve with respect to the bottom portion of the first diaphragm 71 shown in FIG. 16(b), and a curve d is a characteristic curve with respect to the outer circumference portion of the first diaphragm 71 shown in FIG. 16(b).

On the other hand, FIG. 24 shows, during driving of a conventional speaker device, an example of a characteristic of a vibration acceleration with respect to a frequency at each point of a first diaphragm forming the speaker device. The meanings of curves a to d are similar to those in the case of FIG. 23. “The conventional speaker device” described herein refers to a speaker device including a structure where a voice coil supporting part, a fabric auxiliary cap, and a cap (first diaphragm) are fixed to each other by an adhesive or the like, as disclosed in Japanese Patent Application Laid-Open Publication No. 2006-157840. In the conventional speaker device, the velocity of sound transmitted to a diaphragm (second diaphragm) is different from the velocity of sound transmitted to the first diaphragm from the voice coil supporting part via the auxiliary cap. Thus, as shown in FIG. 24, there were cases where a peak of “squeaking” (especially, refer to the curve a for the apex, and the curve b for the curved point) occurs in the vicinity of 400 Hz.

However, as can be seen from FIG. 23, in the speaker device according to the present Embodiment 2, large peak and dip hardly exist in the vicinity of 400 Hz in both of the apex of the first diaphragm 71 (the curve a) and the curved point (the curve b). Additionally, large peak and dip are shifted to a frequency range higher than 400 Hz. That is, the speaker device according to the present Embodiment 2 of the present invention can prevent the occurrence of the “squeaking” (abnormal sound) phenomenon. As a result, it is possible to obtain a desired characteristic, where an undesired vibration is removed in an actually used range, as a subwoofer used for a low frequency reproduction.

Furthermore, in the present Embodiment 2 of the present invention, the connecting member 73 is structured by connecting the inner circumference portion 73a and the outer circumference portion 73b with the plurality of leg portions 73c. Therefore, it is possible to reduce the weight of the connecting member 73. In addition, for example, when an odd number of leg portions 73c are formed, it is possible to prevent a divided resonance which occurs in the first diaphragm 71 and the second diaphragm 72.

### Embodiment 3

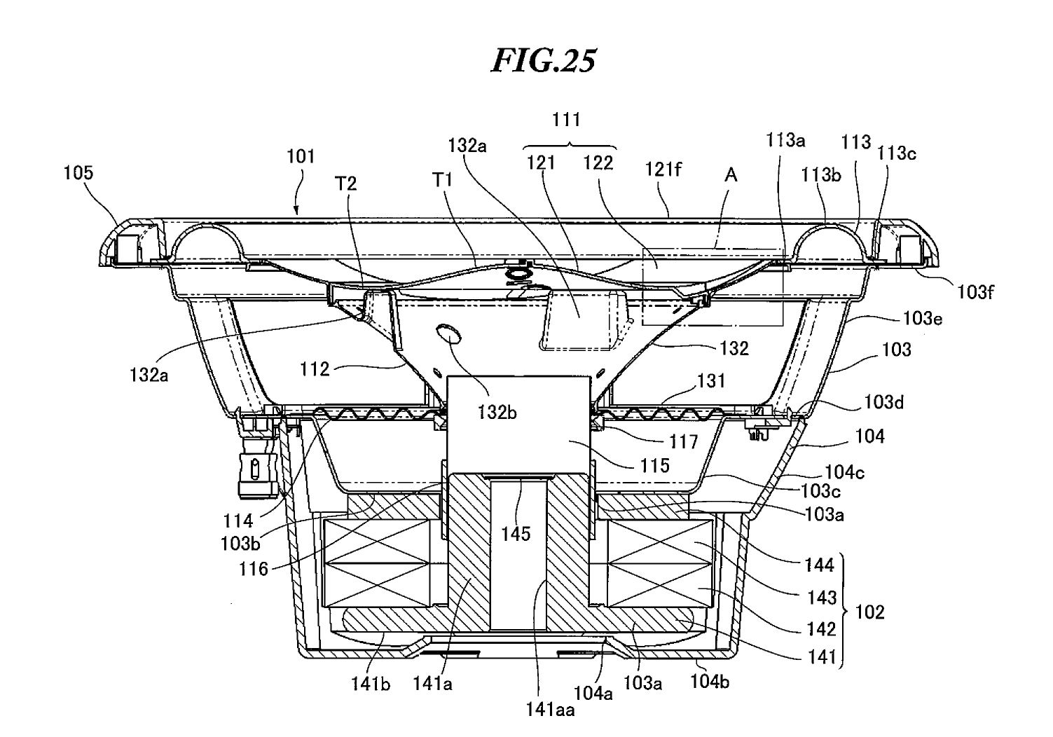

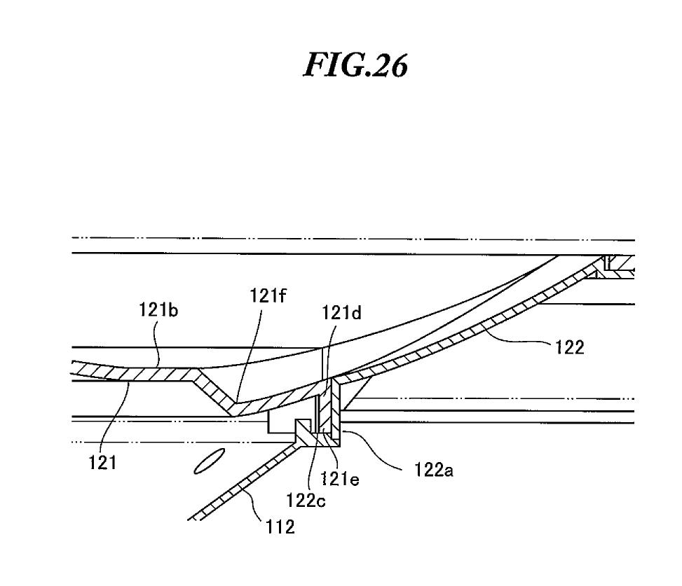

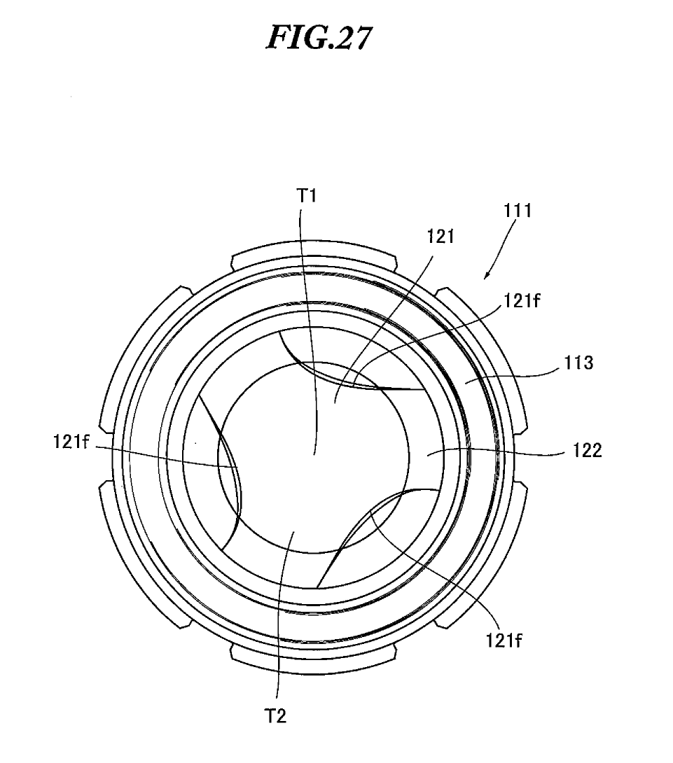

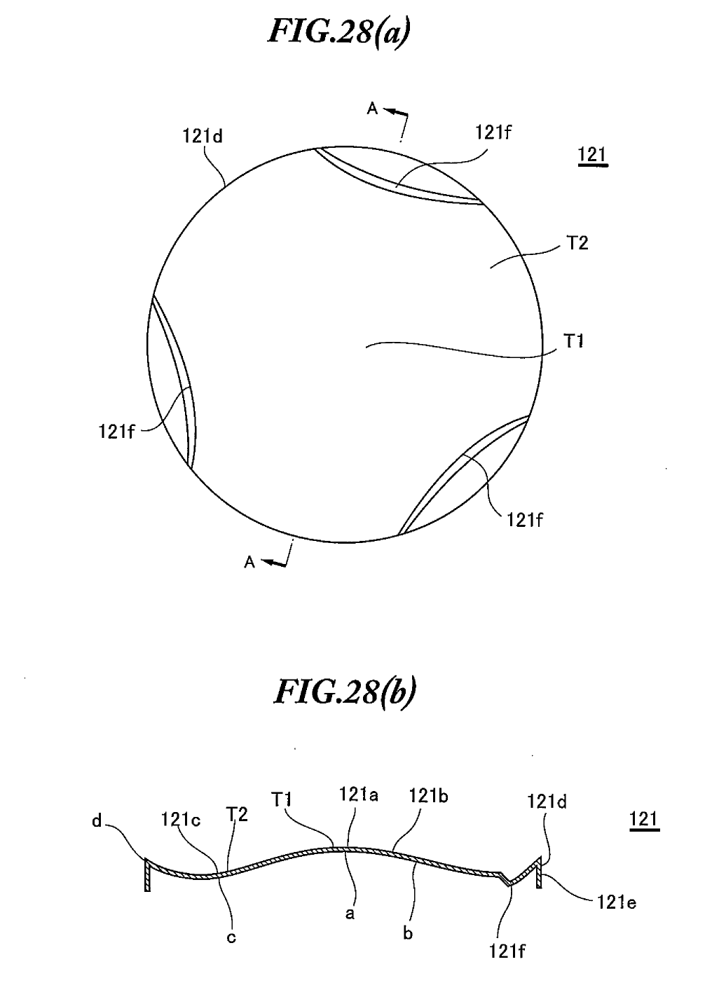

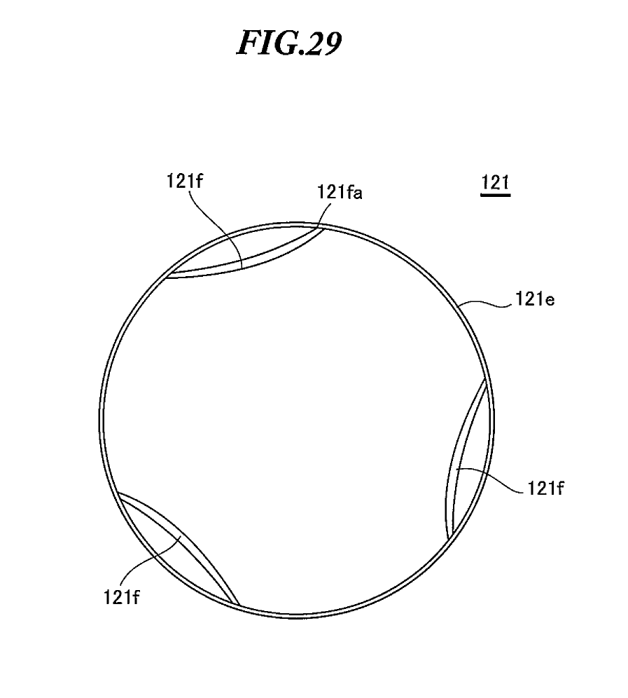

FIG. 25 is a cross-sectional view showing a structure of a speaker device according to Embodiment 3 of the present invention, FIG. 26 is an enlarged view of a portion A in FIG. 25, and FIG. 27 is a front view showing a state where an edge 113 is attached to a diaphragm group 111. Additionally, FIG. 28 includes views showing a structure of a first diaphragm 121, wherein (a) is a front view, and (b) is an A-A cross-sectional view of (a), and FIG. 29 is a rear view showing the structure of the first diaphragm 121.

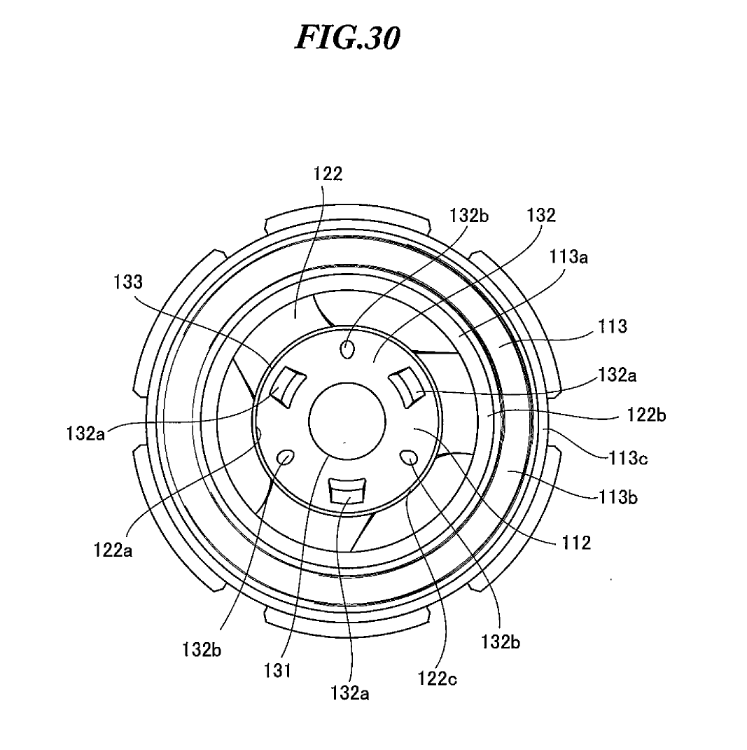

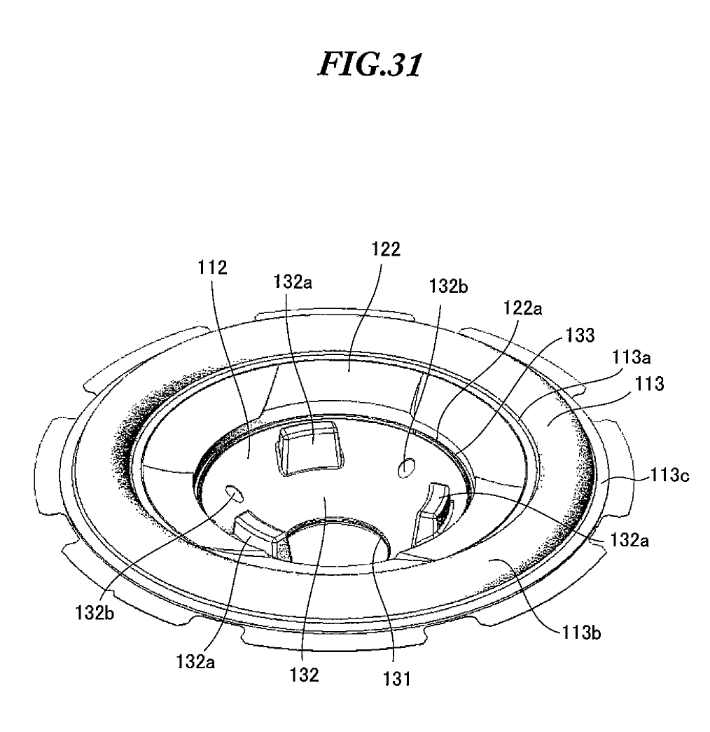

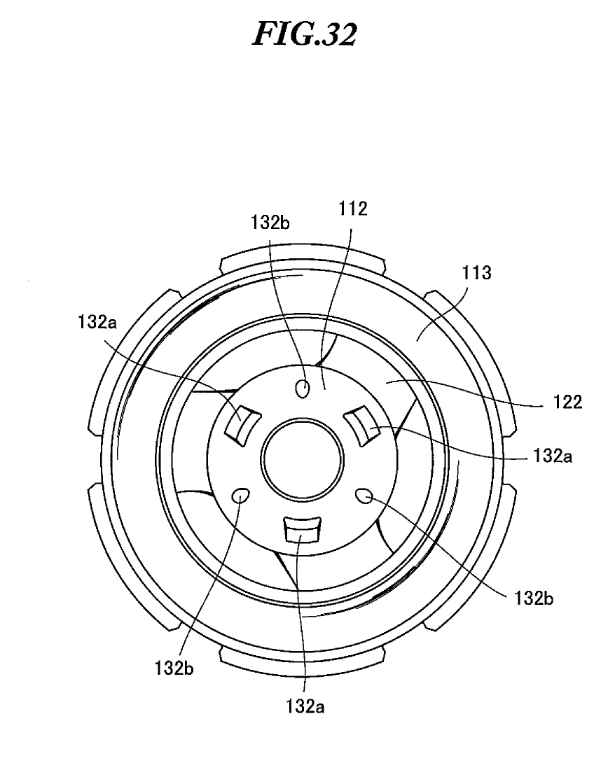

Further, FIG. 30 is a front view showing a state where the edge 113 is attached to a second diaphragm 122, FIG. 31 is a perspective view showing the state where the edge 113 is attached to the second diaphragm 122, and FIG. 32 is a rear view showing the state where the edge 113 is attached to the second diaphragm 122.

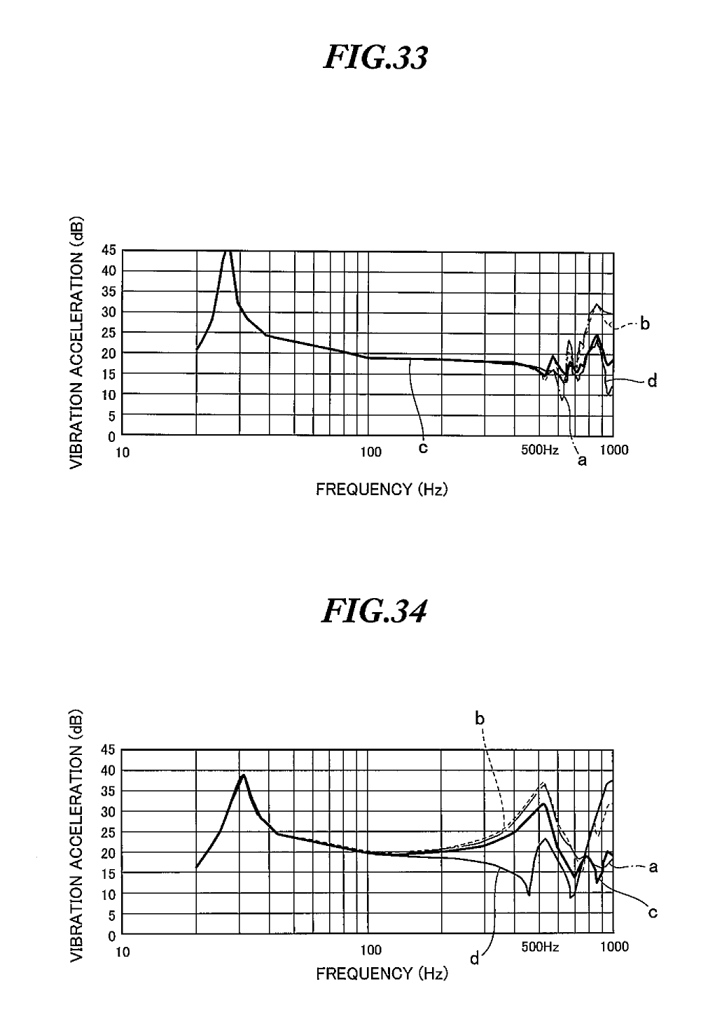

In addition, FIG. 33 is a graph showing, during driving of the speaker device according to Embodiment 3 of the present invention, an example of a characteristic of vibration acceleration with respect to frequency at each point of the first diaphragm 121 which forms the speaker device, and FIG. 34 is a graph showing, during driving of a conventional speaker device, an example of a characteristic of vibration acceleration with respect to frequency at each point of the first diaphragm which forms the speaker device.

The speaker device according to Embodiment 3 includes a vibrating body 101, a magnetic circuit 102, a first frame (speaker frame) 103, and a second frame (speaker frame) 104, and is especially preferably used as a low-frequency reproduction speaker, such as a subwoofer. The vibrating body 101 includes the diaphragm group 111, a driving member (drive cone) 112, the edge 113, a damper 114, a voice coil supporting part (voice coil bobbin) 115, and a voice coil 116.

Hereinafter, a description is given of each constituent element of the speaker device with reference to the drawings. The diaphragm group 111 includes the first diaphragm (center cap) 121 and the second diaphragm 122. The first diaphragm 121 and the second diaphragm 122 are made of, for example, the same material as the first diaphragm 21 and the second diaphragm 22 described above.

As shown in FIG. 25 and FIG. 27, the diaphragm group 111 is a substantially circular shape in a plan view in a state where the first diaphragm 121 and the second diaphragm 122 are fixed to each other by an adhesive or the like. Additionally, the diaphragm group 111 in this fixed state forms a continuous curved face which includes a convex cross-sectional portion T1 in a center portion, and includes a concave cross-sectional portion T2 in a circumference portion. In this manner, since a longitudinal section shape of the diaphragm group 111 includes the convex cross-sectional portion T1 and the concave cross-sectional portion T2, the depth of a vibration surface is reduced, and thus it is possible to reduce the phase difference between a sound wave emitted from the convex cross-sectional portion T1 and a sound wave emitted from the concave cross-sectional portion T2. On this occasion, by further reducing the difference in the depth between the convex cross-sectional portion T1 and the concave cross-sectional portion T2, it is possible to eliminate the problem of the phase difference in a large diameter diaphragm which deteriorates the sound quality of the speaker device due to heaves of undesired sound and attenuation, which are caused by the phase difference occurred between a sound wave emitted from the center portion of the diaphragm and a sound wave emitted from a peripheral portion.

Additionally, the diaphragm group 111 forms the continuous curved face including the center convex cross-sectional portion T1 and concave cross-sectional portion T2 in the outer circumference of the center convex cross-sectional portion. Hence, a driving force exerted from the voice coil supporting part 115 to the diaphragm group 111 is exerted substantially equally on the diaphragm group 111 forming the continuous curved face which is axisymmetric with respect to the center. This continuous curved face forms the vibrating body 101 which can suppress the occurrence of a divided vibration as in a cone-shape and a dome-shape.

Further, the diaphragm group 111 is the continuous curved face, and thus does not include a conventional discontinuous bent portion. Accordingly, it is possible to prevent concentration of stress on the vibrating body 101 even at the time of a large reproduction with a large amplitude, and to obtain the vibrating body 101 having a comparatively high durability. In addition, it is avoided as much as possible to form a bent portion on a surface of the diaphragm group 111. Hence, dust or the like is hardly accumulated, a good vibration characteristic of the diaphragm group 111 can be maintained, and the vibrating body 101 with a good appearance can also be obtained. Further, since the continuous curved face of the diaphragm group 111 can make it impossible to recognize the presence of the first diaphragm 121, it is possible to obtain the vibrating body 101 with a good appearance. Also, since the first diaphragm 121 prevents dust or the like from entering the voice coil supporting part 115, the magnetic circuit 102 and the like, it is possible to maintain good operations of the voice coil supporting part 115, the magnetic circuit 102 and the like.

The first diaphragm 121 is a substantially disc shape in a plan view as shown in FIG. 28(a). The first diaphragm 121 is a curved shape in a longitudinal sectional view where a top portion 121a, an inclined portion 121b, a bottom portion 121c, and a outer circumference portion 121d continue smoothly as shown in FIG. 28(b). In the present Embodiment 3, the convex cross-sectional portion T1 and the concave cross-sectional portion T2 are formed on the surface of the first diaphragm 121. This solves the above-described problem of the phase difference between the emitted sound waves, and reinforces the first diaphragm 121 itself. When the vibrating body 101 is strongly vibrated in order to reproduce loud sound, a large air resistance is exerted on the first diaphragm 121, and a deformation occurs such as a dent. Due to this deformation, it becomes difficult to reproduce a sound wave having the same phase, which leads to a deterioration of the sound quality. In addition, the so-called “squeaking” (abnormal sound) phenomenon may occur since the first diaphragm 121 itself is vibrated. In order to prevent this, the convex cross-sectional portion T1 and the concave cross-sectional portion T2 are formed on the surface of the first diaphragm 121 itself, thereby reinforcing the first diaphragm 121. This prevents a deformation or a vibration of the first diaphragm 121, and as a result, the sound quality is improved, and the occurrence of abnormal sound is prevented.

As shown in FIG. 28(b) and FIG. 29, a fringe portion 121e, which hangs in a substantially vertical direction, is integrally formed with the outer circumference portion 121d and on a rear surface of the first diaphragm 121. The fringe portion 121e is fitted into, as shown in FIG. 26, a groove portion 122c (refer to FIG. 30) having a substantially annular shape which is formed in contact with an inner circumference portion 122a of the second diaphragm 122, and the first diaphragm is locked. Accordingly, the second diaphragm 122 supports the first diaphragm 121 by applying an adhesive on one or both of the fringe portion 121e and the groove portion 122c, and thereafter engaging the fringe portion 121e with the groove portion 122c.

Further, as shown in FIG. 25 through FIG. 29, a plurality of surface shape portions 121f are formed on the surface of the first diaphragm 121. In the present Embodiment 3, three surface shape portions 121f are formed. It is possible to comparatively increase the rigidity by forming these surface shape portions 121f in a continuous shape which continues from the first diaphragm 121 to the second diaphragm 122. Additionally, it is possible to improve the design by covering the boundary between the first diaphragm 121 and the second diaphragm 122. These surface shape portions 121f are formed to have a reinforcing function with respect to an external force of vibrations exerted in a concentric manner. It should be noted that, as shown in FIG. 29, a locking protrusion 121fa is integrally formed in a boundary portion with the fringe portion 121e and on a rear surface of one of these surface shape portions 121f. When the first diaphragm 121 is attached to the second diaphragm 122, the locking protrusion 121fa is engaged with a notched portion 122ca (refer to FIG. 30) formed in the groove portion 122c, and thus is locked to prevent a rotation of the first diaphragm with respect to the second diaphragm 122. In this manner, it is possible to form the surface shape portions 121f of the first diaphragm 121 in continuous shapes which continue from the first diaphragm 121 to the second diaphragm 122.

On the other hand, the second diaphragm 122 has a substantially annular shape as shown in FIG. 30. The second diaphragm 122 is formed such that the inner circumference portion 122a has the inner diameter smaller than the outer diameter (refer to FIG. 28(a)) of the outer circumference portion 121d of the first diaphragm 121. The above-described groove portion 122c is formed in contact with the inner circumference portion 122a of the second diaphragm 122. The groove portion 122c is a substantially annular shape. The groove portion 122c supports the outer circumference portion 121d of the first diaphragm 121 such that the surface of the first diaphragm 121 and the surface of the second diaphragm 122 form a continuous surface in the vibrating body 101.

As shown in FIG. 25 and FIG. 30 through FIG. 32, the driving member 112 is integrally formed in the inner circumference portion and on the rear surface of the second diaphragm 122. As shown in FIG. 30 through FIG. 32, in the driving member 112 an inner circumference portion 131, a cone-shaped portion 132, and an outer circumference portion 133 are integrally formed. The driving member 112 includes a plurality of connecting parts 132a which support the concave cross-sectional portion T2 of the first diaphragm 121, and transmits a driving force of the voice coil supporting part 115 to the diaphragm group 11 via the outer circumference portion 133 and the plurality of connecting parts 132a, thereby driving the diaphragm group 11. Since the driving member 112 is integrally formed with the second diaphragm 122, the driving member 112 is made of the same material as the second diaphragm 122. It should be noted that the driving member 112 may be formed separately from the second diaphragm 122, and in this case, the driving member 112 may be formed of the same material as the second diaphragm 122 or of a different material from the second diaphragm 122. The driving member 112 is a substantially annular shape in a plan view.

As shown in FIG. 25, the inner circumference portion 131 of the driving member 112 is fixed, by an adhesive or the like, to an outer circumference face of the voice coil supporting part 115 having a substantially cylindrical shape. The voice coil supporting part 115 is made of, for example, the same material as the above-described voice coil supporting parts 15 and 65. Additionally, an inner circumference portion of the damper 114 is fixed, by an adhesive or the like, to the inner circumference portion 131 of the driving member 112 and in the vicinity of the fixed portion of the voice coil supporting part 115.

The damper 114 has an appropriate compliance (rigidity). The damper 114 is formed by, for example, impregnating a cloth with a phenolic-type resin or the like, or with a solution of a phenolic-type resin and an organic solvent, or the like, and by thermoforming. The damper 114 is a substantially annular shape in a plan view. A curved portion and a flat portion are integrally formed in order from the inner circumference portion toward the outer circumference portion.

A rear surface of the flat portion forming the damper 114 is fixed, by an adhesive or the like, to a surface of a center flat portion 103d forming the first frame 103. The curved portion has a concentric shape. Namely, each cross-sectional shape of the curved portion of the damper 114 includes a plurality of convex portions and concave portions. The inner circumference portion 131 of the driving member 112 is connected to the first frame 103 via the voice coil supporting part 115 and the damper 114. In other words, the damper 114 elastically supports the inner circumference portion 131 of the driving member 112 with respect to the first frame 103 in the inner circumference portion of the damper 114.

In this manner, in a static state of the speaker device (a state where the speaker device is not driven), the damper 114 elastically supports, together with the edge 113, the first diaphragm 121, the second diaphragm 122, the voice coil supporting part 115, and the voice coil 116 at respective predetermined positions in the speaker device. Additionally, the damper 114 elastically holds the voice coil 116 and the voice coil supporting part 115 at predetermined positions which avoid contacting with the member constituting the magnetic circuit 102, such as a yoke 141, magnets 142 and 143, and a plate 144. Further, in a driving state of the speaker device, the damper 114 also serves to elastically support the first diaphragm 121, the second diaphragm 122, the voice coil supporting part 115, and the voice coil 115 along a vibration direction.

Additionally, in order to reinforce the joint strength in the fixed portion between the voice coil supporting part 115 and the driving member 112, as shown in FIG. 25, a reinforcing member 117 is provided closer to the magnetic circuit 102 than the fixed portion between the inner circumference portion 131 of the driving member 112 and the voice coil supporting part 115. The reinforcing member 118 is a substantially annular shape. The reinforcing member 117 is made of, for example, the same material as the above-described reinforcing members 18 and 68. Since the speaker device includes the reinforcing member 117, for example, the joint portion between the voice coil supporting part 115 and the driving member 112 has a comparatively high joint strength. Thus, it is possible to emit a comparatively high sound wave. Further, when vibrating the diaphragm group 111 and the driving member 112 at a large amplitude, a high stress is exerted on the fixed portion between the driving member 112 and the voice coil supporting part 115, and the voice coil supporting part 115 is prone to be deflected. However, since the voice coil supporting part 115 includes the reinforcing member 117, it is possible to prevent the occurrence of a deflection.

The voice coil 116 is wound around the outer circumference face of the voice coil supporting part 115 in the vicinity of a rear end portion thereof (on the magnetic circuit 102 side) as shown in FIG. 25. Similar to the above-described reinforcing members 18 and 68, a plurality of protruding portions (not shown) are formed in an inner circumference portion of the reinforcing member 117 in a circumferential manner and toward the voice coil supporting part 115, so as to form a predetermined interval with respect to the outer circumference surface of the voice coil supporting part 115. The pair of lead lines, each of which is electrically connected to either end of the voice coil 116, pass between the protruding portions of the reinforcing member 117 and between the reinforcing member 117 and the voice coil supporting part 115, are pulled out in the vicinity of an upper end portion along the outer circumference portion of the voice coil supporting part 115, and are electrically connected to a pair of wires arranged between, for example, the driving member 112 and the diaphragm group 111. The pair of wires are, for example, lead lines which are formed by twisting a plurality of thin electric wires and are strong against bending, conductive lines subjected to a braiding process, or the like.

The cone-shaped portion (extending portion) 132 is formed continuously with the inner circumference portion 131 of the driving member 112. The cone-shaped portion 132 is a substantially cone shape extending toward the surface side (sound emission direction) from the inner circumference portion 131 to the outer circumference portion 133. The plurality of connecting parts 132a are integrally formed from the substantially center portion to the boundary portion with the outer circumference portion 133 in the radial direction of the cone-shaped portion 132. In the present Embodiment 3, three connecting parts 132a are formed. Each of the connecting parts 132a is a substantially fan shape in a plan view, the connecting parts 132a are separated from each other with a predetermined interval, and are formed in the positions where the connecting parts 132a opposing with respect to the center of the inner circumference portion 131 become substantially symmetric to each other. Each of the connecting parts 132a supports, as a whole, the first diaphragm 121 by fixing, by, for example, an adhesive or the like, the vicinity of the outer circumference portion 121d and the rear surface of the first diaphragm 121.

As in a conventional manner, in the driving member (the drive cone) 112, in a case where the supporting part supporting the first diaphragm 121 is formed into a substantially annular shape, due to the material of the first diaphragm 121 (for example, an ABS resin) or the limitation of a shape as a thin subwoofer (a thickness is comparatively small though a diameter is large), when the speaker device is driven, there is a possibility that the so-called “squeaking” (an abnormal sound) phenomenon occurs where a vibration acceleration at a specific position of the first diaphragm 121 at a predetermined frequency becomes comparatively higher than a vibration acceleration at another point.

However, in the present Embodiment 3, each of the connecting parts 132a is not a substantially annular shape but a shape divided in a circumferential direction. Thus, it is possible to make the vibration acceleration of the first diaphragm 121 close to the vibration acceleration of the second diaphragm 122. Hence, it is possible to prevent such a “squeaking” (an abnormal sound) phenomenon. Additionally, by connecting the driving member 112 to the first diaphragm 121 via the connecting parts 132a, it is possible to comparatively increase the rigidity of the first diaphragm 121 and the driving member 112. Therefore, it is possible to prevent the occurrence of a divided vibration (including a divided resonance) of the first diaphragm 121 and the driving member 112. Further, in the present Embodiment 3, since the plurality of connecting parts 132a support the concave cross-sectional portion T2 of the first diaphragm 121, it is possible to prevent the occurrence of the above-described “squeaking” (abnormal sound) phenomenon.

In the cone-shape portion 132, a plurality of air holes 132b, which are for introducing the air into the speaker device from the outside, are bored between each of the connecting parts 132a. In the present Embodiment 3, three air holes 132b are bored.

An inner circumference portion 113a of the edge 113 is fixed, by an adhesive or the like, to the outer circumference portion of the second diaphragm 122 as shown in FIG. 25, FIG. 27 and the like. The edge 113 has an appropriate compliance (rigidity), and is not air-permeable. The edge 113 is constituted by integrally forming the inner circumference portion 113a, a convex portion 113b, and an outer circumference portion 113c. The edge 113 is a substantially annular shape in an entire plan view. Longitudinal cross-sectional shapes of the inner circumference portion 113a and the outer circumference portion 113c are flat shapes. Meanwhile, a longitudinal cross-sectional shape of the convex portion 113b is a substantially roll shape protruding toward the surface side (sound emission direction). The outer circumference portion 113c is fixed by an adhesive or the like to an upper flat portion 103f of the first frame 103, which will be described later, as shown in FIG. 25. In this manner, as shown in FIG. 25, the diaphragm group 111 is connected to the first frame 103 via the edge 113. In other words, the edge 113 elastically supports the diaphragm group 111 with respect to the first frame 103. The edge 113 is made of, for example, the same material as the above-described edges 13 and 63.

Next, a description will be given of a structure of the magnetic circuit 102. The magnetic circuit 102 is, as shown in FIG. 25, an outer-magnet type which interposes the magnets 142 and 143 between the yoke 141 and the plate 144. Additionally, in the present Embodiment 3, an example is shown where an outer-magnet type magnetic circuit is used. However, this is not the limitation, and an inner-magnet type magnetic circuit may be employed.

The yoke 141 is made of, for example, the same material as the above-described yokes 41 and 91. The yoke 141 is structured by integrally forming a tube portion 141a formed in a center portion and having a substantially cylindrical shape, and a flange portion 141a formed into a shape which extends toward the outside in the radial direction from a bottom portion of the tube portion 141a. A through hole 141aa is bored in a center portion of the tube portion 141a. A sheet-like dust proof member 145 having an air-permeability is provided on an upper portion of the tube portion 141a. The outer diameter of the tube portion 141a is slightly smaller than the inner diameter of the voice coil supporting part 115. The tube portion 141a is loosely inserted inside the voice coil supporting part 115. The flange portion 141b is a substantially annular shape in a plan view. Additionally, the magnets 142 and 143 are sequentially fixed by, for example, an adhesive or the like, to a surface (in the sound emission direction) of the flange portion 141b.

The magnets 142 and 143 are made of, for example, the same material as the above-described magnets 42, 92 and 93. Each of the magnets 142 and 143 is a substantially annular shape, and is a substantially same shape. The reason why the magnets 142 and 143 are stacked is the same as the reason why the magnets 92 and 93 are stacked.

The plate 144 is made of, for example, the same material as the above-described plates 43, 94 and 95. The plate 144 is a substantially annular shape. The inner diameter of the plate 144 is slightly larger than the outer diameter of the voice coil 116 which is wound around the outer circumference face in the vicinity of the rear end portion of the voice coil supporting part 115.

The yoke 141, the magnets 142 and 143, and the plate 144 are formed into substantially concentric shapes, and are fixed to the first frame 103 and the second frame 104 such that the respective central axes in a thickness direction coincide with each other, and, for example, the fixing members 97 and 98, which are not shown, are fixed to the first frame 103 and the second frame 104 by an adhesive or the like. Additionally, the magnetic circuit 102, which is formed by the yoke 141, the magnets 142 and 143, and the plate 144, is formed such that the outer diameter of the flange portion 141b of the yoke 141, outer diameters of the magnets 142 and 143, and the outer diameter of the plate 144 become substantially identical. In the present Embodiment 3, the outer diameters of the magnets 142 and 143 are formed to be comparatively larger than the outer diameter of the flange portion 141b and the outer diameter of the plate 144. The outer diameter of the magnetic circuit 102 according to the present Embodiment 3 is, for example, the average value, the maximum value, or the minimum value of the outer diameters of the yoke 141, the magnets 142 and 143, the plate 144 and the like. Further, in the magnetic circuit 102, a magnetic gap is formed between an inner circumference portion of the plate 144 and an outer circumference portion of the tube portion 141a of the yoke 141. A substantially uniform magnetic flux density distribution is formed over an entire circumference of the magnetic gap.

The first frame 103 is, as shown in FIG. 25, a substantially U-shape in a cross-sectional view where a diameter is increased from a lower portion toward an upper portion. More specifically, in the first frame 103, an opening 103a, having the inner diameter which is substantially equal to the inner diameter of the plate 144, is formed in the bottom portion, and a lower flat portion 103b is formed in the vicinity of the opening 103a. The magnetic circuit 102 is fixed to the lower flat portion 103b by, for example, an adhesive.

Additionally, in the first frame 103, a curved portion 103c is formed which extends from the lower flat portion 103b to the outside in the radial direction and has a shape curved in the sound emission direction. The center flat portion 103d is formed in an upper portion of the curved portion 103c. A flat portion of the damper 114 is fixed to the center flat portion 103d by, for example, an adhesive or the like. That is, the outer circumference portion of the diaphragm group 111 is supported by the center flat portion 103d of the first frame 103 via the damper 114.

Further, in the first frame 103, a curved portion 103e is formed which extends from the center flat portion 103d to the outside in the radial direction and has a shape curved in the sound emission direction. The upper flat portion 103f is formed in an upper portion of the curved portion 103e. The outer circumference portion 113c of the edge 113 is fixed to the upper flat portion 103f by, for example, an adhesive or the like. That is, the outer circumference portion of the diaphragm group 111 is supported by the upper flat portion 103f of the first frame 103 via the edge 113. A protection member 105 is mounted on the upper portion of the first frame 103 as shown in FIG. 25. The protection member 105 has, for example, a substantially annular shape in a plan view and a protruding shape in a cross-sectional view. A top portion of the protection member 105 is formed higher than the edge 113, and includes a function of preventing a problem that an obstacle contacts the edge 113 or the diaphragm group 111.

On the other hand, the second frame 104 has, as shown in FIG. 25, a substantially U-shape in a cross-sectional view where a diameter is increased from a lower portion toward an upper portion. More specifically, in the second frame 104, an opening 104a, having the inner diameter which is substantially equal to the outer diameter of the tube portion 141a of the yoke 141, is formed in a bottom portion, and a lower flat portion 104b is formed in the vicinity of the opening 104a. The magnetic circuit 102 is fixed to the lower flat portion 104b by, for example, an adhesive or the like.

Additionally, a curved portion 104c is formed which extends from the lower flat portion 104b to the outside in the radial direction, and has a shape curved in the sound emission direction. The first frame 103 and 104 are made of, for example, the same material as the above-described frames 3, 54 and 55. The first frame 103 is connected to the second frame 104 via the magnetic circuit 102.

As mentioned above, according to Embodiment 3 of the present invention, in the speaker device including the first diaphragm 121 and the second diaphragm 122, the connecting parts 132a, which forms the driving member 112, support the vicinity of the fringe portion 121e in the rear surface of the first diaphragm 121. Hence, it is possible to prevent the occurrence of the so-called “squeaking” (an abnormal sound) phenomenon of the first diaphragm 121 where a peak occurs in the vicinity of 500 Hz.

Here, FIG. 33 shows, when driving the speaker device according to Embodiment 3 of the present invention, an example of a characteristic of a vibration acceleration with respect to a frequency at each point of the first diaphragm 121 which forms the speaker device. In FIG. 33, a curve a is a characteristic curve with respect to the apex of the first diaphragm 121 shown in FIG. 28(b), a curve b is a characteristic curve with respect to a curved point of the first diaphragm 121 shown in FIG. 28(b), a curve c is a characteristic curve with respect to a bottom portion of the first diaphragm 121 shown in FIG. 28(b), and a curve d is a characteristic curve with respect to the outer circumference portion of the first diaphragm 121 shown in FIG. 28(b).

On the other hand, FIG. 34 shows, when driving a conventional speaker device, an example of a characteristic of a vibration acceleration with respect to a frequency at each point of a first diaphragm which forms the speaker device. The meanings of curves a to d are similar to those in the case of FIG. 33. “The conventional speaker device” described herein refers to the speaker device as described in Patent Document 1. In the conventional speaker device, the rigidity in the vicinity of the center portion is low with respect to the rigidity of the outer circumference portion of the center cap. Thus, a peak of “squeaking” could occur in the vicinity of 500 Hz as shown in FIG. 34.

However, as can be seen from FIG. 33, in the speaker device according to Embodiment 3 of the present invention, a large peak/dip does not exist in the vicinity of 500 Hz at any point of the first diaphragm 121. Additionally, a large peak/dip is shifted to a frequency domain higher than 500 Hz. That is, it is possible for the speaker device according to Embodiment 3 of the present invention to prevent the occurrence of the “squeaking” (the abnormal sound) phenomenon. As a result, it is possible to obtain a desired characteristic, where an undesired vibration is removed in an actually used range, as a high power subwoofer used for a low band reproduction.

Additionally, according to the present Embodiment 3, by connecting the plurality of connecting parts 132a, which are formed from the substantially center portion toward the boundary portion with the outer circumference portion 133 in the radial direction of the cone-shaped portion 132 forming the driving member 112 by the first diaphragm 121, it becomes possible to reinforce the strength, adjust a frequency characteristic, and adjust a high-frequency cutoff characteristic of the cone-shaped portion 132.

Further, a divided vibration mode, where a bending occurs in a circumferential direction, is likely to occur in the second diaphragm 122 and the driving member 112, and this is likely to occur at an even order. However, according to the present Embodiment 3, by providing an odd number of connection portions 132a in the cone-shaped portion 132 forming the driving member 112, it is possible to suppress bending in the circumferential direction of the second diaphragm 122 and the driving member 112. In addition, according to the present Embodiment 3, as in the above-described Embodiment 1, it is possible to bore a through hole for inserting wires in an area of the cone-shaped portion 132 where the connecting parts 132a are not formed. Thus, wiring becomes easy.

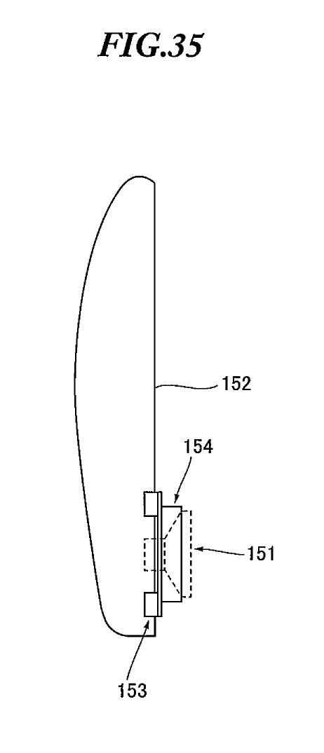

FIG. 35 is a cross-sectional view illustrating a structure of a door 152 of a vehicle to which a speaker device 151 according to each embodiment of the present invention is attached. In FIG. 35, a bracket 153 is arranged on a rear surface of the door 152, a unit member 154 is attached to a surface of the door 152, and the speaker device 151 is attached via the unit member 154.

Hereinbefore, a detailed description is given of the embodiments of the present invention with reference to the drawings. However, specific structures are not limited to these embodiments, and the present invention includes modifications of designs and the like within a scope of the gist of the present invention.

For example, in the above-described Embodiment 1, the plurality of first connecting parts 32a are formed in the cone-shaped portion 32 forming the driving member 12, and a portion relating to connection is not particularly formed in the rear surface of the first diaphragm 21. However, this is not the limitation. The plurality of first connecting parts 32a and a portion (for example, a concave portion or a rib) for connecting these may be formed on the rear surface of the first diaphragm 21.

Additionally, it is possible to divert the techniques of each of the above-described embodiments to each other as long as there is no particular contradiction or problem in their objects, structures and the like.

1. A speaker device, comprising:
a vibrating body;
a driving part which drives the vibrating body; and
a frame which supports the vibrating body and the driving part,
the vibrating body including a voice coil, a voice coil supporting part supporting the voice coil, a diaphragm, and a driving member whose inner circumference portion is supported by the voice coil supporting part, the driving member transmitting a vibration of the voice coil to the diaphragm,
the driving member including a supporting part which supports the diaphragm,
wherein a connecting part is provided between the diaphragm and the driving member and on an inside with respect to the supporting part, and
the diaphragm is connected to the driving member via the connecting part.

2. The speaker device according to claim 1,
wherein the driving member includes at least an extending portion which extends toward a sound emission direction between the inner circumference portion and an outer circumference portion, and
the connecting part is provided at the extending portion.

3. The speaker device according to claim 2, wherein the diaphragm is formed into a flat shape.

4. The speaker device according to claim 3,
wherein the diaphragm includes a first diaphragm and a substantially annular second diaphragm surrounding the first diaphragm,
the supporting part supports the second diaphragm, and
the connecting part connects with the first diaphragm.

5. The speaker device according to claim 4,
wherein an outer diameter of the first diaphragm is formed larger than an inner diameter of the second diaphragm,
the first diaphragm is arranged on the second diaphragm, and
a continuous face is formed from the first diaphragm to the second diaphragm.

6. The speaker device according to claim 5, wherein an outer circumference portion of the first diaphragm is supported by the second diaphragm between an inner circumference portion and an outer circumference portion of the second diaphragm.

7. The speaker device according to claim 6,
wherein the driving member includes an inversed extending portion extending in a direction opposite to the sound emission direction between an inner circumference portion and the outer circumference portion of the driving member, and a folded portion formed between the extending portion and the inversed extending portion, and
the supporting part is the folded portion.

8. The speaker device according to claim 7, wherein an inner circumference portion of the second diaphragm is supported by the folded portion.

9. The speaker device according to claim 8,
wherein a second connecting part is arranged between the inversed extending portion and the second diaphragm, and
the second diaphragm is supported by the inversed extending portion via the second connecting part.

10. The speaker device according to claim 9, wherein a plurality of connecting parts is provided on a circumference of the driving member.

11. The speaker device according to claim 8, wherein the connecting part is a concentric shape and is formed by a member different from the driving member.

12. The speaker device according to claim 11,
wherein an inner circumference portion of the connecting part is connected to the first diaphragm, and an outer circumference portion of the connecting part is connected to the second diaphragm,
leg portions are provided between an inner circumference portion and an outer circumference portion of the connecting part, and
an opening is formed between the leg portions.

13. The speaker device according to claim 8, wherein an outer circumference portion of the second diaphragm and an outer circumference portion of the driving member are each supported by the frame via an edge.

14. The speaker device according to claim 13,
wherein a sealed space is formed which is surrounded by the second diaphragm, the driving member, and the frame, and
an air within the sealed space functions as an air spring.

15. The speaker device according to claim 6, wherein an outer circumference portion of the driving member supports an outer circumference portion of the first diaphragm.

16. The speaker device according to claim 15,
wherein the vibrating body includes an edge supporting the diaphragm to the frame,
the driving member and the second diaphragm are integrally formed, and
an outer circumference portion of the second diaphragm is supported by the frame via an edge.

17. The speaker device according to claim 16,
wherein the vibrating body includes a damper,
an inner circumference portion of the damper is connected to the voice coil supporting part, and
an outer circumference portion of the damper is connected to the frame.

18. The speaker device according to claim 6, wherein the first diaphragm includes a curved cross-sectional surface formed by a convex cross-sectional portion formed in a center, and a concave cross-sectional portion continuously formed from the convex cross-sectional portion toward an outside.

19. The speaker device according to claim 18, wherein a total height of the diaphragm is shorter than a total height of the driving member.

20. The speaker device according to claim 19, wherein the concave cross-sectional portion of the first diaphragm is supported by the connecting part.

21. The speaker device according to claim 1, wherein the connecting part and the driving member are formed by members having the substantially same propagation speed as a member forming the voice coil supporting part, the propagation speed being determined by a Young's modulus and a density of the member forming the voice coil supporting part.

22. The speaker device according to claim 6, wherein the magnetic circuit includes a plate, a magnet, and a yoke.

23. The speaker device according to claim 6, wherein a plurality of through holes are arranged in a circumferential manner in the voice coil supporting part.

24. The speaker device according to claim 6,
wherein a reinforcing member supporting an inner circumference portion of the driving member is attached to the voice coil supporting part,
the reinforcing member includes, in an inner circumference portion of the reinforcing member, an opening for passing lead lines which are pulled out from the voice coil and a joint portion which is joined with the voice coil supporting part, and
a groove portion to which an inner circumference portion of the driving member is attached is provided between an inner circumference portion and an outer circumference portion of the reinforcing member.

25. The speaker device according to claim 13,
wherein an edge attached to an outer circumference portion of the second diaphragm includes a convex curved face portion in a sound emission direction, and
a cross-sectional shape of an edge attached to an outer circumference portion of the driving member includes a convex curved portion which is convex toward a sound emission direction, and a plurality of concave curved face portions arranged adjacent to the convex curved face portion.

26. The speaker device according to claim 8, wherein the voice coil supporting part is supported by the first diaphragm.

27. The speaker device according to claim 8, wherein an annular member formed by a metal member is arranged on a joint position between the first diaphragm and the second diaphragm.

28. A vehicle comprising the speaker device according to claim 1.
